(19) United States
(12) Patent Application Publication
(10) Pub. No.: US 2012/0176418 A1
(43) Pub. Date: Jul. 12, 2012

(54) ELECTRO-OPTICAL DEVICE, DRIVING METHOD OF ELECTRO-OPTICAL DEVICE, AND ELECTRONIC EQUIPMENT

(75) Inventor: Shinsuke Fujikawa, Chino-shi (JP)

(73) Assignee: Seiko Epson Corporation, Tokyo (JP)

(21) Appl. No.: 13/340,284

(22) Filed: Dec. 29, 2011

(30) Foreign Application Priority Data
Jan. 12, 2011 (JP) 2011-004278

(51) Int. Cl. G09G 5/10

(52) U.S. Cl. 345/690

(57) ABSTRACT

A display area is divided into two upper and lower areas, and with respect to a first area, data of a first subfield is written to a memory in a pixel. If the writing is ended, display of the first subfield of the first area is performed and also data of a second subfield is written to the memory in the pixel. If the writing of the data of the second subfield with respect to the first area is ended, display of the second subfield of the first area is performed and also the data of the first subfield of the second area is written to the memory in the pixel. If the writing is ended, display of the first subfield of the second area is performed and also the data of the second subfield is written to the memory in the pixel.

### BACKGROUND

1. Technical Field

The present invention relates to a technique of performing gradation control by subfield driving.

2. Related Art

In an electro-optical device having a liquid crystal element as a pixel, there is an electro-optical device which expresses intermediate gradation by subfield driving. The subfield driving is for on-driving or off-driving pixels for each subfield obtained by dividing a frame into a plurality of subfields and expresses each gradation by changing the subfield that is on-driven or off-driven or the proportion of a time of on-driving or off-driving. When performing high-gradation expression by the subfield driving in this manner, a short subfield period is required. However, as a technique of realizing a short subfield period, there is a technique disclosed in JP-A-2001-337643.

In a display device disclosed in JP-A-2001-337643, in a case where the number of rows of scanning lines is a number from 0 to 1079, in the case of making a subfield period shorter than a scanning period from the 0th row to the 1079th row, first, after a screen is once made to be black display, pixels from the 0th row to the 539th row are sequentially driven, and if the driving of the 539th row is ended, the pixels from the 0th row to the 539th row are sequentially subjected to black display. Next, the pixels from the 540th row to the 1079th row are sequentially driven, and if the driving of the 1079th row is ended, the pixels from the 540th row to the 1079th row are sequentially subjected to black display. That is, in the display device disclosed in JP-A-2001-337643, a display area is divided into plural areas arranged up and down, and after black display is performed in each divided area, a subfield period of each area is set to be a time of half of a scanning period of one screen. Here, since in each area, the subfield period is shorter than the scanning period from the 0th row to the 1079th row, in the display device disclosed in JP-A-2001-337643, compared to the configuration of performing the subfield driving without dividing a display area, a shorter subfield period is realized, so that it is possible to express higher gradation.

However, in the display device disclosed in JP-A-2001-337643, when making the subfield period shorter than a horizontal scanning period of one screen, black display is necessarily performed before the driving of the divided areas, so that there is a problem in that display becomes dark.

### SUMMARY

An advantage of some aspects of the invention is that it drives a pixel in a shorter subfield period than a vertical scanning period of one screen, thereby preventing display from becoming dark.

According to an aspect of the invention, there is provided an electro-optical device including: a plurality of pixels provided corresponding to the respective intersections of a plurality of scanning lines with a plurality of data lines; and a driving circuit that writes data to the pixels in accordance with subfield data constituted by a bit array according to a gradation level, with each subfield obtained by dividing one frame into a plurality of subfields as a unit, wherein the pixel includes a first memory which is connected to the scanning line and the data line and stores data supplied to the data line when the scanning line has been selected, a second memory which stores the data stored in the first memory, and a pixel driving circuit which on-drives or off-drives the pixel depending on the data stored in the second memory, the driving circuit divides the plurality of scanning lines into a plurality of groups, selects the plurality of groups in a predetermined order, writes a bit based on the subfield data to the first memory of the selected pixel among the plurality of pixels, and stores the content of the first memory in the second memory of the selected pixel after the writing is ended, and at least two different weightings are given to a plurality of subfield periods and the plurality of subfield periods are assigned at different timings with respect to each of the plurality of groups.

According to this configuration, in each group, the writing time of data in one subfield becomes short compared to a case where the scanning lines are not divided into a plurality of groups. Further, since the writing of data is performed for each group, with respect to the pixels related to each group, it is possible to make the display period of one subfield short compared to a case where the scanning lines are not grouped. Further, since weighted subfields can be realized without reducing writing efficiency to each pixel row (a scanning line selection speed), gradation expressiveness is improved.

In the configuration, in the groups, the scanning lines that belong to another group may be located between the plural scanning lines that belong to one group.

According to this configuration, since the scanning lines are grouped in a toothcomb shape, in the case of displaying a moving image, the boundaries of the pixels related to groups become less noticeable, so that movement of a picture becomes natural.

Further, in the configuration, the pixel may be alternating-current driven and a bit corresponding to the last sub-frame in one frame in the subfield data may be a bit that off-drives the pixel.

According to this configuration, since a voltage that is applied to the pixel when performing polarity reversion of voltage that is applied to the pixel in the alternating-current driving becomes a voltage that becomes the standard of driving, it is possible to prevent an increase in voltage applied after the polarity reversion between adjacent pixels.

In addition, the invention can also be conceptualized as a method of driving the electro-optical device and electronic equipment that includes the electro-optical device, besides the electro-optical device. As such electronic equipment, a projector which expands and projects a light modulation image by an electro-optical device can be given.

### BRIEF DESCRIPTION OF THE DRAWINGS

The invention will be described with reference to the accompanying drawings, wherein like numbers reference like elements.

FIG. 1 is a diagram illustrating the configuration of an electro-optical device related to a first embodiment.

FIG. 2 is a diagram illustrating a frame in the electro-optical device.

FIG. 3 is a diagram illustrating the contents of an LUT.

FIG. 4 is a diagram illustrating the configuration of a display panel.

FIG. 5 is a diagram illustrating the configuration of a data line driving circuit.

FIG. 6 is a timing chart of the data line driving circuit.

FIG. 7 is a diagram illustrating the configuration of a pixel.

FIG. 8 is a timing chart for describing an operation of the display panel.

FIG. 9 is a diagram illustrating the progress of the writing of data to the pixels in a display area.

FIG. 10 is a diagram illustrating the configuration of a display panel related to a second embodiment.

FIG. 11 is a timing chart for describing an operation of the display panel.

FIG. 12 is a diagram illustrating the progress of the writing of data to the pixels in the display area.

FIG. 13 is a diagram illustrating the configuration of an electro-optical device related to a third embodiment.

FIG. 14 is a diagram illustrating the configuration of a display panel related to the third embodiment.

FIG. 15 is a timing chart for describing an operation of the display panel.

FIG. 16 is a diagram illustrating the progress of the writing of data to the pixels in the display area.

FIG. 17 is a diagram illustrating the configuration of a display panel related to a fourth embodiment.

FIG. 18 is a timing chart for describing an operation of the display panel.

FIG. 19 is a diagram illustrating the progress of the writing of data to the pixels in the display area.

FIG. 20 is a diagram illustrating the configuration of a projector with a liquid crystal panel applied thereto.

FIG. 21 is a diagram illustrating the progress of the writing of data to the pixels in the display area.

### DESCRIPTION OF EXEMPLARY EMBODIMENTS

### First Embodiment

### Configuration in the Embodiment

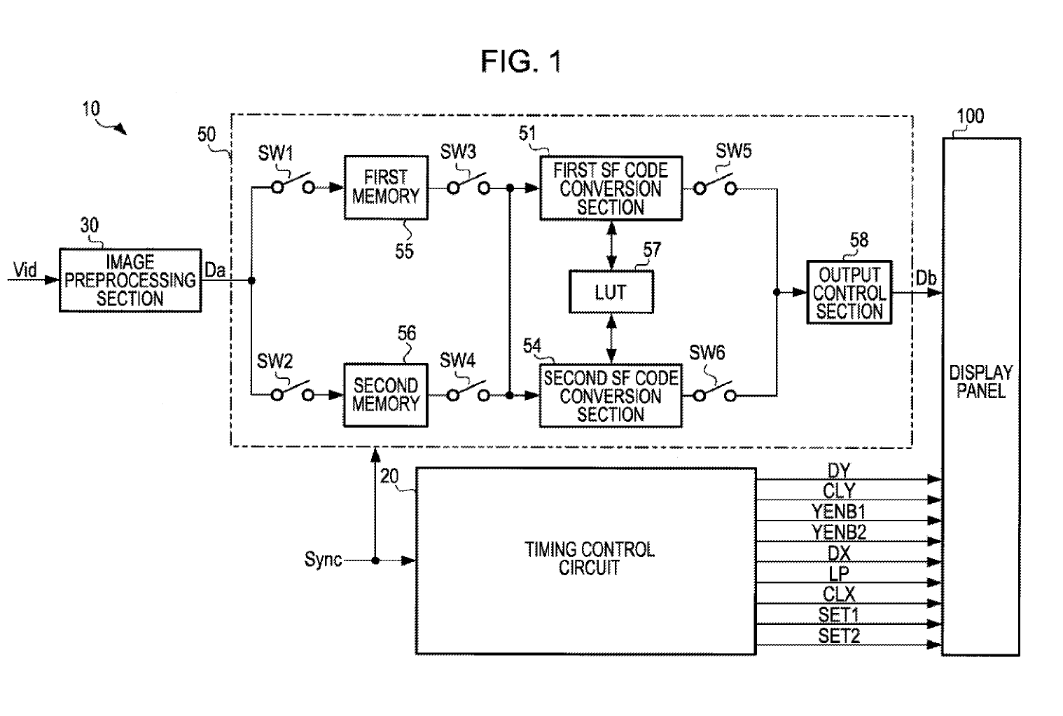

FIG. 1 is a block diagram illustrating the overall configuration of an electro-optical device 10 related to an embodiment of the invention. The electro-optical device 10 is an electro-optical device which displays an image by subfield driving. The electro-optical device 10 includes a timing control circuit 20, an image preprocessing section 30, a decoder 50, and a display panel 100. A video signal Vid is supplied from a high-order circuit (not shown) to the electro-optical device 10, in accordance with a synchronization signal Sync. Here, the video signal Vid is for defining a gradation level of each pixel in an image which should be displayed, and is supplied in the order of pixels which are scanned in accordance with a vertical synchronization signal, a horizontal synchronization signal, and a dot clock signal (all not shown) which are included in the synchronization signal Sync.

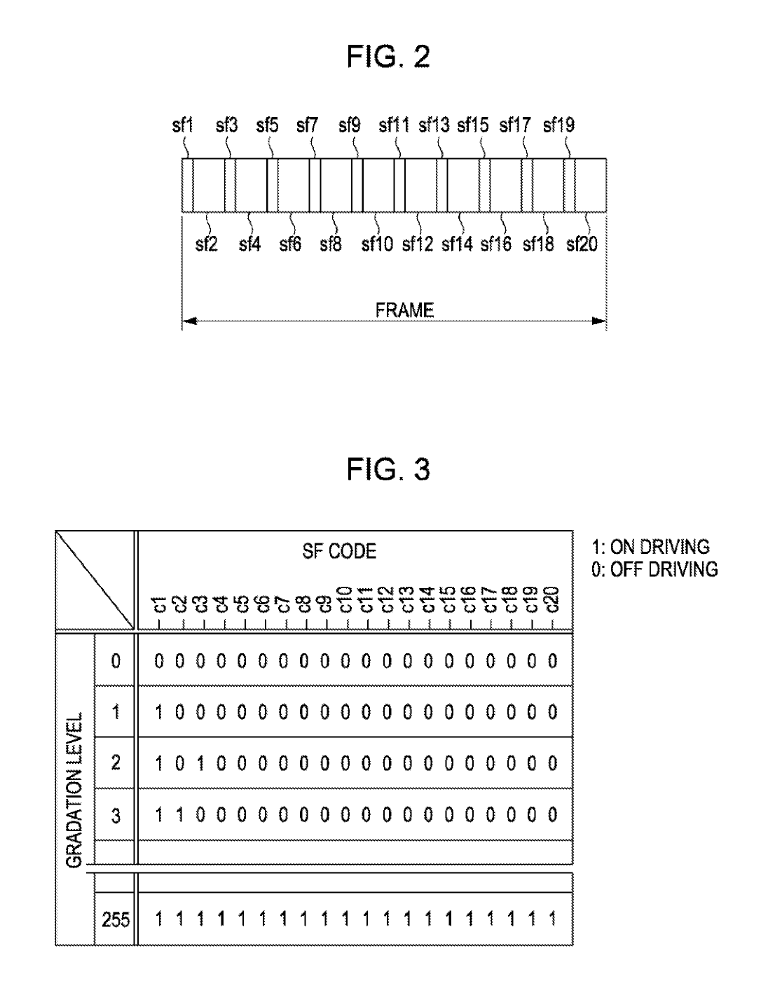

In addition, in this embodiment, one frame that is a unit period in which gradation is controlled with respect to each pixel has a configuration shown in FIG. 2. As shown in the drawing, the frame is divided into a total of 20 subfields. In this embodiment, since the frame is constituted by a total of 20 subfields, in order to distinguish these subfields, the subfields are denoted by sf1 to sf20 in a temporal sequence. Further, in this embodiment, weighting of an odd-numbered subfield and an even-numbered subfield is set to be 1 in the odd-numbered subfield and 3 in the even-numbered subfield.

The image preprocessing section 30 is for preprocessing brightness, color tone, or the like of an image which is represented by the video signal Vid which is input, according to the display properties of the display panel 100 or the setting statuses of various operating elements (not shown), and outputs a preprocessed signal Da. In addition, in this embodiment, the video signal Vid may also be an analog signal and may also be a digital signal. However, if it is an analog signal, it is converted into a digital signal by the image preprocessing section 30. Further, in this embodiment, the video signal Da is set to be an 8-bit signal, and a gradation level to be expressed at the pixel is designated by 256 gradations from 03-5909-11820” that is the darkest level to “255” that is the brightest level with increments of “1” in a decimal value.

The timing control circuit 20 generates signals such as a start pulse DY, a clock signal CLY, an output control signal YENB1, and an output control signal YENB2 on the basis of the synchronization signal Sync. The start pulse DY is a pulse signal which is output at the timing of write start of data of the subfield, and the timing of the writing of data of the subfield is controlled by the start pulse DY. The clock signal CLY is a pulse signal which defines a horizontal scanning period (1H). The output control signal YENB1 and the output control signal YENB2 are pulse signals which control an output of a scanning signal which will be described later.

Further, the timing control circuit 20 generates signals such as a start pulse DX, a latch pulse LP, a clock signal CLX, a display control signal SET1, and a display control signal SET2. The start pulse DX is a pulse signal which is output at the beginning of the horizontal scanning period, and is output at the time of a level transition of the clock signal CLY, that is, at the time of rising and the time of falling. The clock signal CLX is a dot clock signal for data writing to the pixel (specifically, a memory built in the pixel) of the display panel 100. The latch pulse LP is a pulse signal which is output once in the horizontal scanning period, and performs an operation of transferring data all at once from a first latch circuit group 1404 to a second latch circuit group 1406. The display control signals SET1 and SET2 are pulse signals which update the state of the pixel.

The decoder 50 is for generating an SF code depending on the gradation level of the video signal Da. The decoder 50 has a first memory 55 and a second memory 56 which store the video signal Da for one frame. Further, the decoder 50 has a first SF code conversion section 51 which converts the video signal Da stored in the first memory 55 or the second memory 56 into the SF code, a second SF code conversion section 52 which converts the video signal Da stored in the first memory 55 or the second memory 56 into the SF code, and an LUT (Look Up Table) 57 which represents a correspondence relationship between the gradation level and the SF code.

Here, FIG. 3 is a diagram illustrating the contents of the LUT 57. As shown in the drawing, in the LUT 57, the gradation level and the SF code are correlated with each other. The SF code uses an optical responsiveness in a liquid crystal element. The SF code is composed of 20 bits, SF (subfield) bits c1 to c20, and the SF bits c1 to c20 are arranged in order as bits which designate ON/OFF driving of the subfields sf1 to sf20.

The first SF code conversion section 51 reads the video signal Da which is stored in the first memory 55 or the second memory 56, and converts gradation that the read-out video signal Da represents, into the SF code with reference to the LUT 57. Further, the second SF code conversion section 52 reads the video signal Da which is stored in the first memory 55 or the second memory 56, and converts gradation that the read-out video signal Da represents, into the SF code with reference to the LUT 57.

Further, the decoder 50 has an output control section 58 and switches SW1 to SW6. The output control section 58 outputs any one bit of the SF code obtained in the first SF code conversion section 51 or the second SF code conversion section 52 to the display panel 100 as an SF bit Db. In addition, the bit of the SF code is 0 or 1, and in a case where the bit is 0, the SF bit Db turns into an L-level signal, and in a case where the bit is 1, the SF bit Db turns into an H-level signal.

The switch SW1 is a switch which supplies the video signal Da to the first memory 55, and the switch SW2 is a switch which supplies the video signal Da to the second memory 56. The switches SW1 and SW2 are controlled on the basis of the vertical synchronization signal that is included in the synchronization signal Sync which is supplied to the decoder 50, and when the switch SW1 is opened, the switch SW2 is closed, and when the switch SW1 is closed, the switch SW2 is opened.

Further, the switch SW3 is a switch which supplies the content of the first memory 55 to the first SF code conversion section 51, and the switch SW4 is a switch which supplies the content of the second memory 56 to the second SF code conversion section 52. The switches SW3 and SW4 are controlled on the basis of the vertical synchronization signal that is included in the synchronization signal Sync which is supplied to the decoder 50, and when the switch SW3 is opened, the switch SW4 is closed, and when the switch SW3 is closed, the switch SW4 is opened.

Further, the switch SW5 is a switch which supplies the SF code obtained in the first SF code conversion section 51 to the output control section 58, and the switch SW6 is a switch which supplies the SF code obtained in the second SF code conversion section 52 to the output control section 58. The switches SW5 and SW6 are controlled on the basis of the vertical synchronization signal and the horizontal synchronization signal that are included in the synchronization signal Sync which is supplied to the decoder 50, and when the switch SW5 is opened, the switch SW6 is closed, and when the switch SW5 is closed, the switch SW6 is opened.

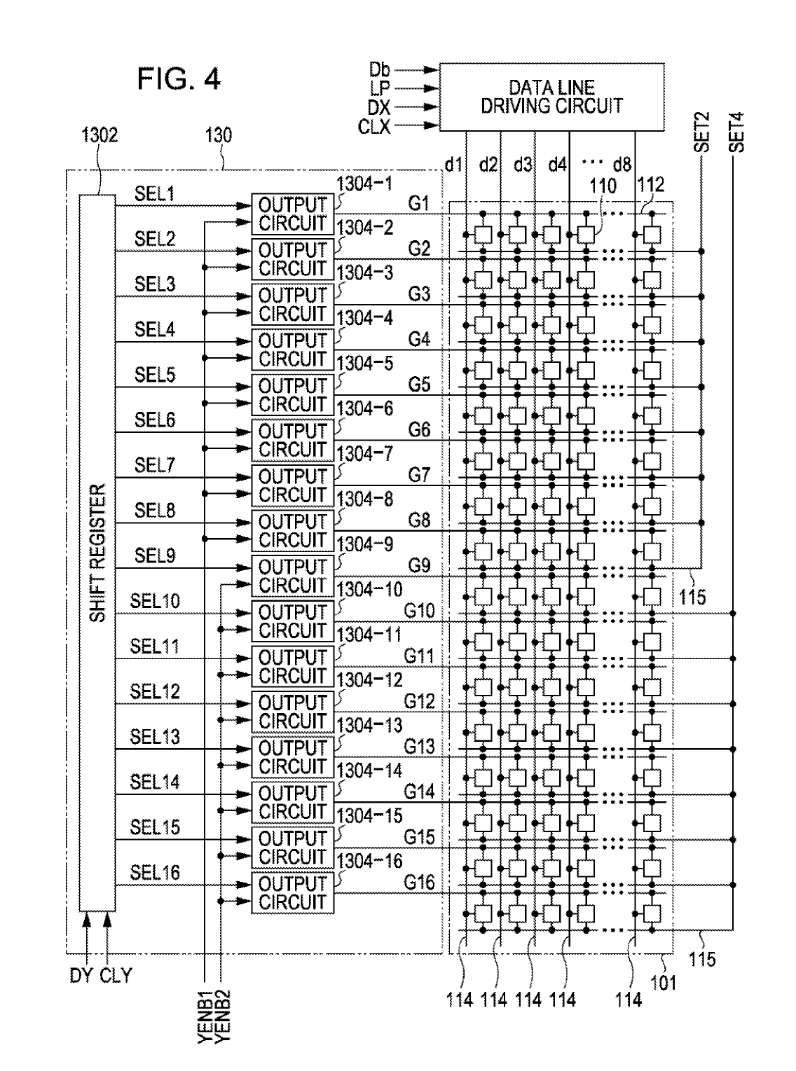

FIG. 4 is a diagram illustrating the configuration of the display panel 100. The display panel 100 is a reflection type liquid crystal display panel. As shown in this drawing, in the display panel 100, scanning lines 112 and control lines 115 of 1-row, 2-row, 3-row, . . . , and m-row are provided so as to extend in a transverse direction in the drawing and data lines 114 of 1-column, 2-column, 3-column, . . . , and n-column are provided so as to extend in a longitudinal direction in the drawing and to be electrically insulated from each scanning line 112 and each control line 115. Then, a pixel 110 is arranged corresponding to each of the intersection points of m rows of scanning lines 112 with n columns of data lines 114. An area where the pixels 110 are arranged becomes a display area 101. In addition, in this embodiment, in order to facilitate explanation, the number of rows (the number of m) of the scanning lines is set to be 16 rows and the number of columns (the number of n) of the data lines is set to be 8 columns. However, the number of rows of the scanning lines and the number of columns of the data lines are not limited to these numbers. Further, in this embodiment, the display area 101 is divided into an area (a first area) having the pixels connected to a group of the scanning lines from the first row to the eighth row and an area (a second area) having the pixels connected to a group of the scanning lines from the ninth row to the sixteenth row.

At the periphery of the display area 101, a scanning line driving circuit 130 and a data line driving circuit 140 are provided. Of these, the scanning line driving circuit 130 is for supplying a scanning signal to each of the scanning lines of 1-row to 16-row. The scanning line driving circuit 130 is a kind of address decoder in which a scanning signal to the scanning line for which selection is designated by a signal which is supplied thereto is set to be selection voltage and on the other hand, scanning signals to other scanning lines related to non-selection are set to be non-selection voltage. In addition, in FIG. 4, the scanning signals which are supplied to the scanning lines 112 of the 1st, 2nd, 3rd, . . . , and 16th rows are respectively denoted by G1, G2, G3, . . . , and G16.

The scanning line driving circuit 130 has a shift register 1302 and output circuits 1304-1 to 1304-16. When the start pulse DY which is supplied at the timing of write start of data of the subfield is in an H level, if the clock signal CLY falls, the shift register 1302 sequentially exclusively outputs latch signals SEL1, SEL2, SEL3, . . . , and SEL16 that are pulse signals corresponding to the scanning lines from the first row to the sixteenth row in accordance with the clock signal CLY. The output circuits 1304-1 to 1304-8 output the pulse of the output control signal YENB1 which is supplied thereto, to the scanning lines 112 as the scanning signal in a case where the latch signals which are supplied from the shift register 1302 are in an H level. Further, the output circuits 1304-9 to 1304-16 output the pulse of the output control signal YENB2 which is supplied thereto, to the scanning lines 112 as the scanning signal in a case where the latch signals which are supplied from the shift register 1302 are in an H level.

On the other hand, the data line driving circuit 140 is for supplying a data signal according to the SF bit Db to each of the data lines 114 of the first to n-th columns in accordance with a signal which is supplied from the timing control circuit 20. In addition, in the drawing, the data signals which are supplied to the data lines 114 of the 1st, 2nd, 3rd, . . . , and n-th columns are respectively denoted by d1, d2, d3, . . . , and dn.

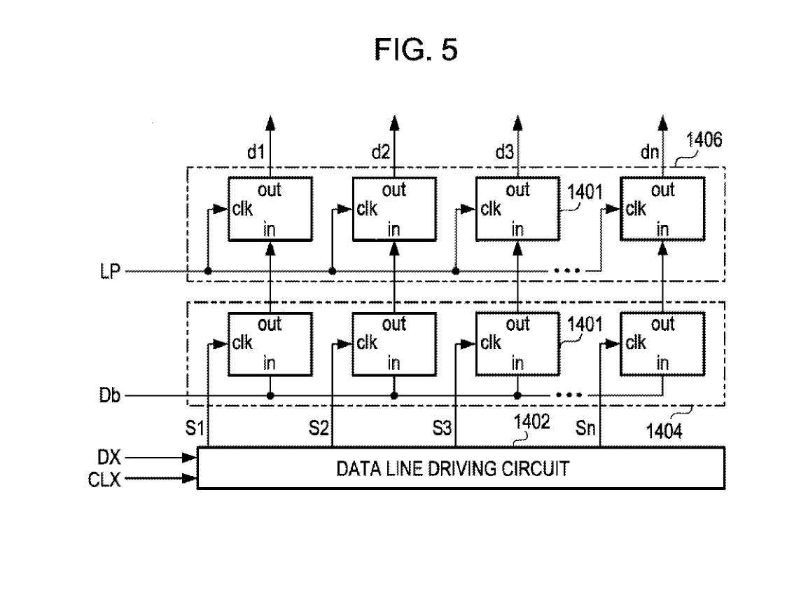

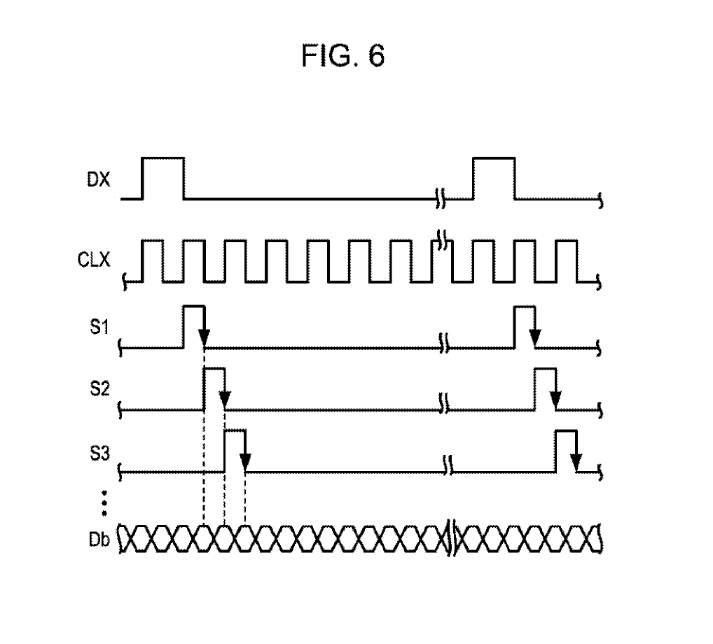

FIG. 5 is a diagram illustrating the configuration of the data line driving circuit 140. Further, FIG. 6 is a timing chart of the data line driving circuit. The data line driving circuit 140 is constituted by a shift register 1402, the first latch circuit group 1404, and the second latch circuit group 1406. As shown in FIG. 6, when the start pulse DX which is supplied at the beginning of the horizontal scanning period is in an H level, if the clock signal CLX falls, the shift register 1402 sequentially exclusively supplies latch signals S1, S2, S3, . . . , and Sn in accordance with the clock signal CLX. Each of the first latch circuit group 1404 and the second latch circuit group 1406 is constituted by a plurality of latch circuits 1401. The latch circuit 1401 is, for example, a D-type flip-flop. The latch circuits 1401 of the first latch circuit group 1404 sequentially latch the SF bit Db that is serial data which is input to in terminals, in the falling of the latch signals S1, S2, S3, . . . , and Sn which are input to clk terminals, as shown in FIG. 6, and output the latched data from out terminals. The latch circuits 1401 of the second latch circuit group 1406 latch the SF bits Db output from the first latch circuit group 1404, in the falling of the latch pulse LP, and output in parallel the latched SF bits Db from out terminals to the data lines 114 as the data signals d1, d2, d3, . . . , and dn.

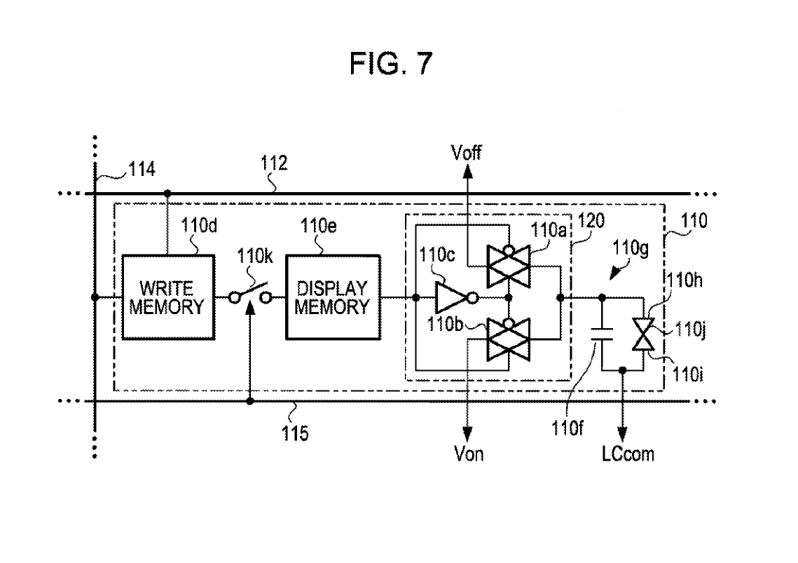

Next, FIG. 7 is a diagram illustrating the configuration of the pixel 110. The pixel 110 is a memory built-in type and has a write memory 110d, a display memory 110e, and a switch 110k. The write memory 110d (a first memory) is a memory that stores a data signal which is supplied from the data line 114. The write memory 110d stores the data signal supplied from the data line 114, in a case where the scanning line 112 is in an H level. The display memory 110e (a second memory) is a memory that stores the data signal which is stored in the write memory 110d. If the switch 110k is closed by the display control signal SET1 (SET2) which is supplied from the control line 115, the data signal which is stored in the write memory 110d is supplied to the display memory 110e, and the display memory 110e stores the supplied data signal.

Further, the pixel 110 has a pixel driving circuit 120 constituted by an inverter 110c and a pair of transmission gates 110a and 110b. In FIG. 7, the output of the display memory 110e is supplied to the gate of a P-channel transistor constituting a portion of the transmission gate 110a and the gate of an N-channel transistor constituting a portion of the transmission gate 110b. Further, the output of the display memory 110e is level-inverted by the inverter 110c and then supplied to the gate of an N-channel transistor of the transmission gate 110a and the gate of a P-channel transistor of the transmission gate 110b. The transmission gates 110a and 110b enter into an ON state in a case where a gate signal of an L level is imparted to the P-channel transistors and a signal of an H level is imparted to the N-channel transistors. Therefore, either of the transmission gates 110a and 110b alternatively enters into an ON state depending on the level of the data signal which is supplied from the display memory 110e. Further, an OFF voltage Voff turning the pixel 110 off is supplied to an input end of the transmission gate 110a on one side and an ON voltage Von turning the pixel 110 on is supplied to an input end of the transmission gate 110b on the other side.

Output ends of the pair of transmission gates 110a and 110b are connected in common to a liquid crystal element 110g and a storage capacitor 110f which are provided in parallel. The liquid crystal element 110g is formed by sandwiching liquid crystal 110j that is an electro-optical material between a pixel electrode 110h and an opposite electrode 110i. The opposite electrode 110i is a transparent electrode which is formed on one surface of an opposite substrate so as to face the pixel electrode 110h formed on an element substrate. The ON voltage Von or the OFF voltage Voff is selectively applied to the pixel electrode 110h depending on the data signal stored in the display memory 110e, and a common voltage LCcom is applied to the opposite electrode 110i. Here, when the liquid crystal element 110g has been set to be a normally black mode, the ON voltage Von means voltage providing a light state by application of voltage to the liquid crystal element 110g, and the OFF voltage Voff means voltage providing a dark state by non-application of voltage to the liquid crystal element 110g (or by application of voltage making an applied voltage be around zero).

In addition, in a case where the liquid crystal element 110a performs alternating-current driving, the ON voltage Von requires two types of polarities, a positive polarity making the voltage be on the high-order side with respect to the common voltage LCcom that is an amplitude center voltage and a negative polarity making the voltage be on the low-order side with respect to the amplitude center voltage. On the other hand, if the OFF voltage Voff is the voltage in a case where voltage is not applied to the liquid crystal element 110g, the OFF voltage Voff is one type of the common voltage LCcom which is applied to the opposite electrode 110i, and is independent of a polarity. However, if the OFF voltage Voff is the voltage in a case where voltage making an applied voltage be around zero is applied, the OFF voltage Voff requires two types of polarities, a positive polarity and a negative polarity with respect to the amplitude center voltage.

In this embodiment, since the pixel 110 is driven in either ON or OFF, the data signal has either an ON level (a voltage level of a driving voltage turning the pixel 110 on) according to “1” of the SF bit Db or an OFF level (a voltage level of a driving voltage turning the pixel 110 off) according to “0”. In a case where the output of the display memory 110e is in an OFF level, the transmission gate 110a on one side enters into an ON state and the transmission gate 110b on the other side enters into an OFF state. Therefore, the OFF voltage Voff (fixed voltage) is applied to the pixel electrode 110h of the liquid crystal element 110g through the transmission gate 110a. As a result, voltage which is applied to the liquid crystal is equivalent to a difference in potential (approximately 0 V) between the voltage Voff on the pixel electrode 110h side and the common voltage LCcom on the opposite electrode side, so that in a case where the liquid crystal element 110g is set to be a normally black mode, the pixel 110 enters into a dark state. In contrast, in a case where the output of the display memory 110e is in an ON level, the transmission gate 110a on one side enters into an OFF state and the transmission gate 110b on the other side enters into an ON state. Therefore, the ON voltage Von is applied to the pixel electrode 110h of the liquid crystal element 110g through the transmission gate 110b. As a result, voltage which is applied to the liquid crystal is equivalent to a difference in potential between the voltage Von on the pixel electrode 110h side and the common voltage LCcom on the opposite electrode side, so that in a case where the liquid crystal element 110g is set to be a normally black mode, the pixel 110 enters into a light state.

### Operation in the Embodiment

Next, an operation of the electro-optical device 10 will be described. First, the video signal Da which is output from the image preprocessing section 30 is supplied to the decoder 50. In the decoder 50, opening/closing of the switches SW1 to SW6 is controlled on the basis of the vertical synchronization signal, and in a case where the switch SW1 is closed, the switch SW2 and the switch SW3 are opened, so that the video signal Da for one frame is stored in the first memory 55. Further, in a case where the switch SW2 is closed, the switch SW1 and the switch SW4 are opened, so that the video signal Da for one frame is stored in the second memory 56. That is, the video signal Da for one frame is alternately stored in the first memory 55 and the second memory 56 for every frame.

In a period in which the switch SW2 is closed, the video signal Da for one frame stored in the first memory 55 is converted into the SF code in the first SF code conversion section 51 and the second SF code conversion section 52. Specifically, the video signal Da for the first area is converted into the SF code in the first SF code conversion section 51 and the video signal Da for the second area is converted into the SF code in the second SF code conversion section 52. The output control section 58 selects and outputs the bit of the SF code obtained in each of the first SF code conversion section 51 and the second SF code conversion section 52, depending on the driving timing (the subfield) of the display panel 100. For example, in a case where the driving timing of the display panel 100 is the subfield sf1, the bit c1 of the SF code of each pixel is supplied to the display panel 100 as the SF bit Db in the order of the pixels which are scanned. In addition, in a period in which the switch SW1 is closed, the video signal Da for one frame stored in the second memory 56 is converted into the SF code in the first SF code conversion section 51 and the second SF code conversion section 52.

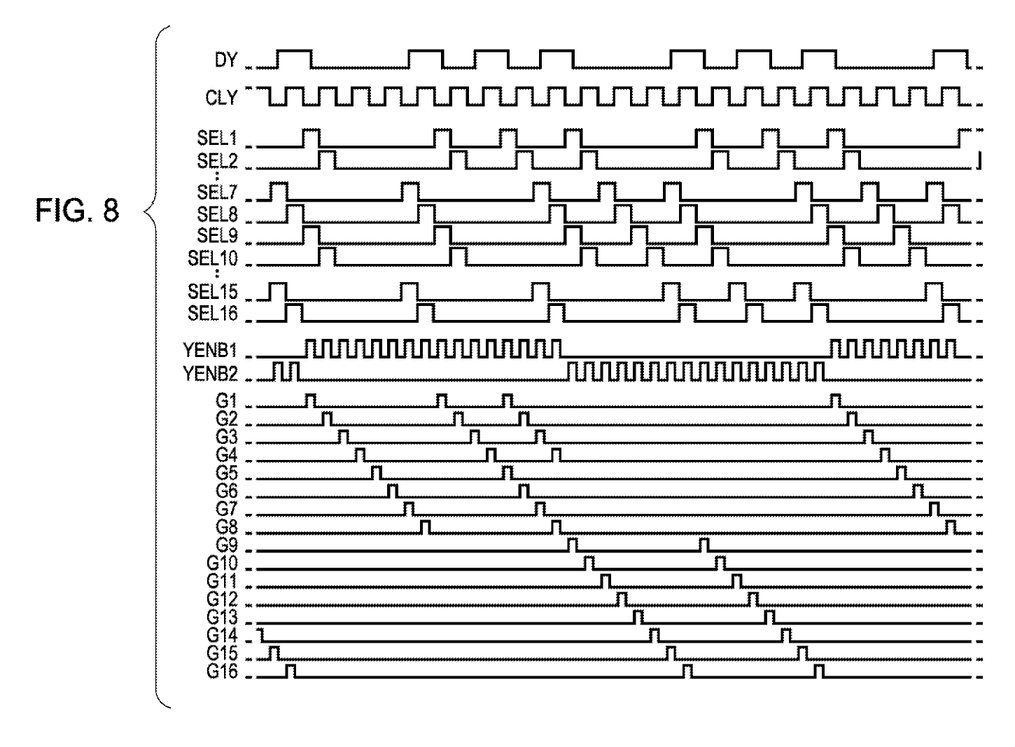

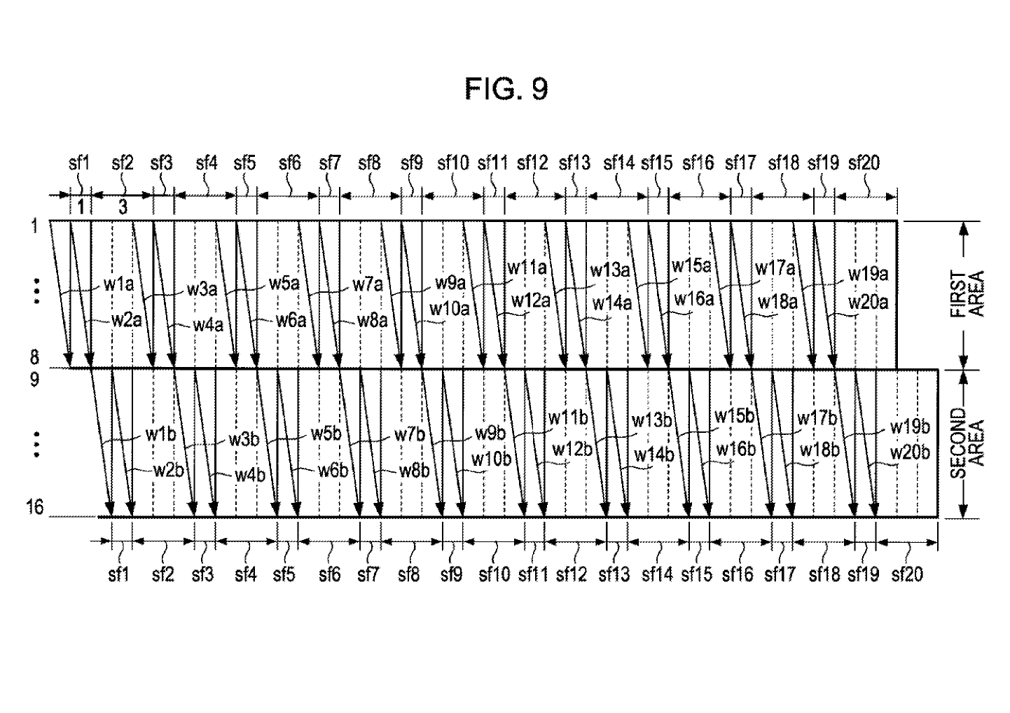

Next, an operation of the display panel 100 will be described. FIG. 8 is a timing chart for describing an operation of the display panel 100. Further, FIG. 9 is a diagram illustrating the progress of the writing of data to the pixels in the display area, wherein a vertical axis represents the rows of the scanning lines and a horizontal axis represents time. Further, in FIG. 9, a display period of one subfield is represented by a rectangular solid line. As shown in FIG. 9, one frame is constituted by the subfields sf1 to sf20, and sf1 to sf20 in FIG. 9 represent the display periods of the respective subfields. In addition, in this embodiment, as described above, the ratio of the display period of the odd-numbered subfield to the display period of the even-numbered subfield is set to be 1:3. Further, w1a to w20a in FIG. 9 represent the timing of the writing of the SF bit Db (the SF bits c1 to c20) in the first area, and w1b to w20b represent the timing of the writing of the SF bit Db in the second area.

If the start pulse DY and the clock signal CLY are supplied to the shift register 1302, first, as shown by w1a in FIG. 9, with respect to the first area, the writing of the SF bit Db of the subfield sf1 is started. Specifically, first, as shown in FIG. 8, the latch signals SEL1, SEL2, SEL3, . . . , and SEL16 are sequentially exclusively output from the shift register 1302 corresponding to the scanning lines from the first row to the sixteenth row. The output circuits 1304-1 to 1304-8 output the pulse of the output control signal YENB1 which is supplied thereto, to the scanning lines 112 as the scanning signal in a case where the latch signals which are supplied thereto are in an H level, and accordingly, the scanning signals G1 to G8 are sequentially output from the output circuits 1304-1 to 1304-8.

On the other hand, in the data line driving circuit 1402, first, with respect to the pixels (of the first area) from the first row to the eighth row, the SF bit Db of the subfield sf1 is latched and the latched SF bit Db is output to the data lines 114 in parallel as the data signal. Specifically, in a period in which the scanning signal G1 is output, the data signals which define the gradation of the pixels from the first column to the eighth column of the first row are output to the data lines 114 in parallel as the data signals d1 to d8, and the data signals d1 to d8 are stored in the write memories 110d. Further, in a period in which the scanning signal G8 is output, the data signals which define the gradation of the pixels from the first column to the eighth column of the eighth row are output to the data lines 114 in parallel as the data signals d1 to d8, and the data signals d1 to d8 are stored in the write memories 110d. If the storage of the data signals with respect to the pixels up to the eighth row is ended, the display control signal SET1 is kept at an H level for a predetermined time, so that the switches 110k of the pixels 110 related to the first row to the eighth row (the first area) are closed. If the switches 110k are closed, the data signals stored in the write memories 110d are stored in the display memories 110e and the pixels 110 of the first area enter into dark states or light states depending on the data signals stored in the display memories 110e (the period of sf1 of the first area in FIG. 9).

Next, as shown by w2a in FIG. 9, with respect to the first area, the writing of the SF bit Db of the subfield sf2 is started. Specifically, when the scanning signal G8 is output, the start pulse DY is output, and the latch signals SEL1, SEL2, SEL3, . . . , and SEL16 are sequentially exclusively output from the shift register 1302. Here, since the pulse of the output control signal YENB1 is supplied, the scanning signals G1 to G8 are sequentially output again. In the data line driving circuit 1402, with respect to each pixel of the first area, the SF bit Db of the subfield sf2 is latched and the latched SF bit Db is output to the data lines 114 in parallel as the data signal. The data signal output to the data line is stored in the write memory 110d. Then, if the storage of the data signal with respect to the pixels up to the eighth row is ended, the display control signal SET1 turns into an H level again, the data signal stored in the write memory 110d is stored in the display memory 110e, and the pixels 110 of the first area enter into dark states or light states depending on the data signals stored in the display memories 110e (the period of sf2 in FIG. 9).

If the writing of the SF bit Db of the subfield sf2 with respect to the first area is ended, as shown by w1b in FIG. 9, with respect to the second area, the writing of the SF bit Db of the subfield sf1 is started. Specifically, when the scanning signal G8 is output, the start pulse DY is output, the output control signal YENB1 turns into an L level, and the output control signal YENB2 is supplied to the scanning line driving circuit 130. If the output control signal YENB2 is supplied to the output circuits 1304-9 to 1304-16, the scanning signals G9 to G16 are sequentially output from the output circuits 1304-9 to 1304-16.

On the other hand, in the data line driving circuit 1402, with respect to the pixels (of the second area) from the ninth row to the sixteenth row, the SF bit Db of the subfield sf1 is latched and the latched SF bit Db is output to the data lines 114 in parallel as the data signal. The data signals output to the data lines are stored in the write memories 110d of the pixels from the ninth row to the sixteenth row. Then, if the storage of the data signals with respect to the pixels up to the sixteenth row is ended, the display control signal SET2 is kept at an H level for a predetermined time, so that the switches 110k of the pixels 110 related to the ninth row to the sixteenth row (the second area) are closed. Then, the data signals stored in the write memories 110d are stored in the display memories 110e and the pixels 110 of the second area enter into dark states or light states depending on the data signals (that is, the SF bit Db of the subfield sf1) stored in the display memories 110e (the period of sf1 of the second area in FIG. 9).

Next, as shown by w2b in FIG. 9, with respect to the second area, the writing of the SF bit Db of the subfield sf2 is started. Specifically, when the scanning signal G16 is output, the start pulse DY is output, and the latch signals SEL1, SEL2, SEL3, . . . , and SEL16 are sequentially exclusively output from the shift register 1302. The latch signals SEL9 to SEL16 are also sequentially exclusively output from the shift register 1302 simultaneously with the output of the latch signals SEL1 to SEL8. Here, since the pulse of the output control signal YENB2 is supplied, the scanning signals G9 to G16 are sequentially output again. In the data line driving circuit 1402, with respect to each pixel of the second area, the SF bit Db of the subfield sf2 is latched and the latched data signal is output to the data lines 114 in parallel. The data signal output to the data line is stored in the write memory 110d. Then, if the storage of the data signal with respect to the pixels up to the sixteenth row is ended, the display control signal SET2 turns into an H level again, the switches 110k of the pixels 110 related to the ninth row to the sixteenth row (the second area) are closed, the data signals stored in the write memories 110d are stored in the display memories 110e, and the pixels 110 of the second area enter into dark states or light states depending on the data signals stored in the display memories 110e (the period of sf2 of the second area in FIG. 9).

Thereafter, as shown in FIG. 9, if the writing of the data signal is performed up to the subfield sf20 by alternately repeating the writing of the SF bits Db of two subfields with respect to the first area and the writing of the SF bits Db of two subfields with respect to the second area, the writing of the data signal is repeated from the subfield sf1 again.

According to this embodiment, since the display area is divided into two equal-width areas, the write time of the data signal of one subfield in each area becomes a half compared to a case where the display area is not divided. Further, since the writing of the data signal is performed for each divided area, with respect to each area, the display period of one subfield can be shortened compared to a case where the display area is not divided. In order to obtain low gradation in the subfield driving, a short subfield period is required. However, in this embodiment, since a short subfield period can be realized, it becomes possible to display low gradation. Further, since black display that is necessarily performed at the time of the writing of a data signal is not performed, display does not become dark.

### Second Embodiment

Next, an electro-optical device related to the second embodiment of the invention will be described. The electro-optical device 10 related to this embodiment is different in the configuration of the scanning line driving circuit, the configuration of the control line 115, and the supply timing of a signal in the display panel 100 from that of the first embodiment.

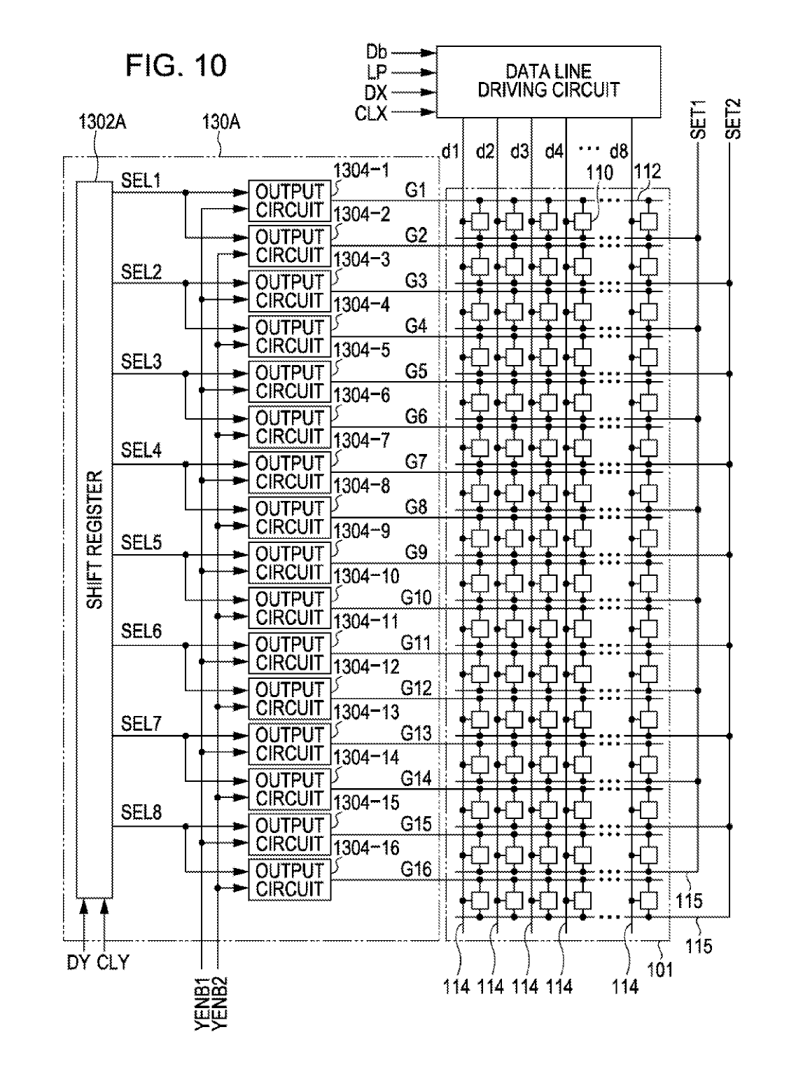

FIG. 10 is a diagram illustrating the configuration of the display panel 100 related to this embodiment. In this embodiment, the display area 101 is divided into an area (a first area) having the pixels connected to a group of the scanning lines of the odd-numbered rows and an area (a second area) having the pixels connected to a group of the scanning lines of the even-numbered rows. That is, in the first embodiment, the scanning lines are grouped and the display area is divided into two areas arranged up and down in a strip shape. However, in this embodiment, the scanning lines are grouped in a toothcomb shape and the first area and the second area are made in a toothcomb shape. Further, in this embodiment, the control line 115 to which the display control signal SET1 is supplied is connected to the pixels 110 to which the scanning lines of the odd-numbered rows are connected, and the control line 115 to which the display control signal SET2 is supplied is connected to the pixels 110 to which the scanning lines of the even-numbered rows are connected.

Further, as shown in FIG. 10, in this embodiment, the display panel 100 has a scanning line driving circuit 130A. The scanning line driving circuit 130A has a shift register 1302A and the output circuits 1304-1 to 1304-16. When the start pulse DY which is supplied at the timing of write start of data of the subfield is in an H level, if the clock signal CLY falls, the shift register 1302A sequentially exclusively outputs the latch signals SEL1, SEL2, SEL3, . . . , and SEL8 that are pulse signals, in accordance with the clock signal CLY. The output circuits 1304 in which the branch numbers of the symbols are odd numbers output the pulse of the output control signal YENB1 which is supplied thereto, to the scanning lines 112 as the scanning signal in a case where the latch signals which are supplied from the shift register 1302A are in an H level. Further, the output circuits 1304 in which the branch numbers of the symbols are even numbers output the pulse of the output control signal YENB2 which is supplied thereto, to the scanning lines 112 as the scanning signal in a case where the latch signals which are supplied from the shift register 1302A are in an H level.

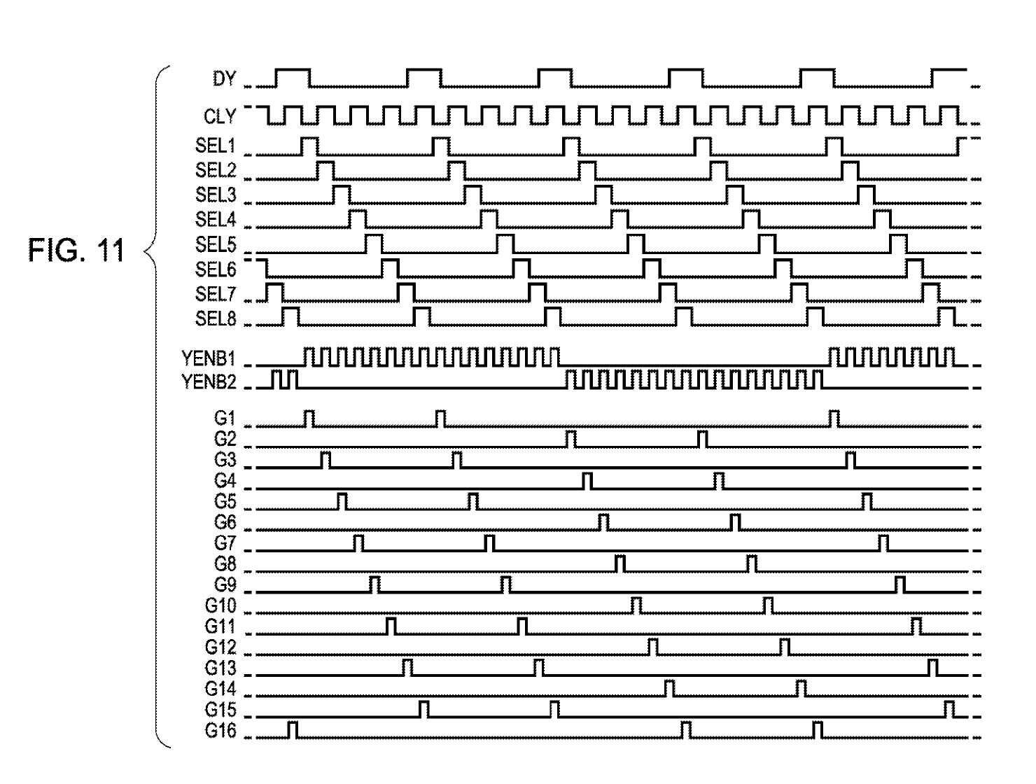

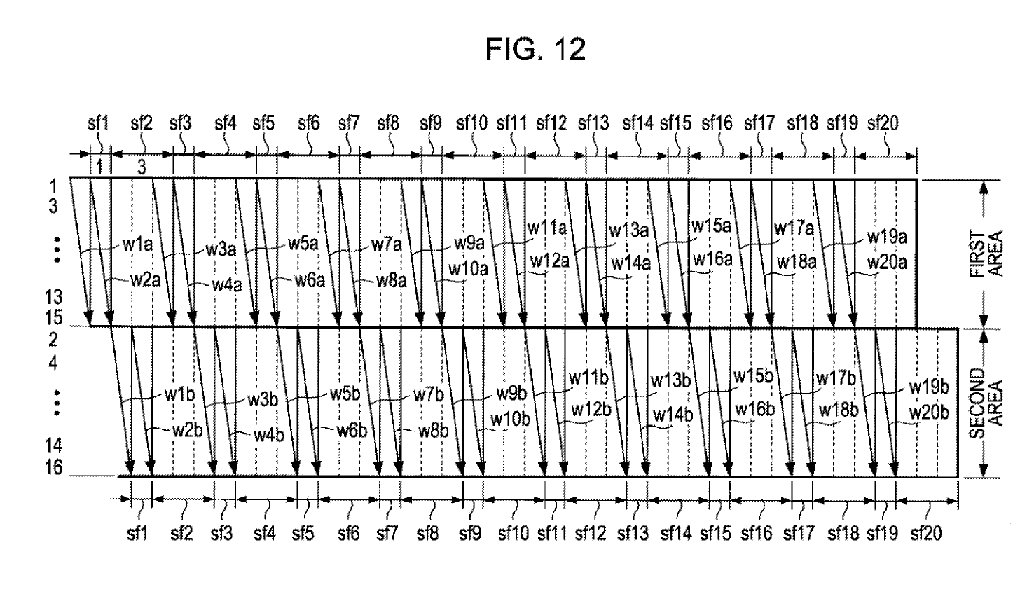

FIG. 11 is a timing chart for describing an operation of the display panel related to this embodiment. Further, FIG. 12 is a diagram illustrating the progress of the writing of data to the pixels in each display area. If the start pulse DY and the clock signal CLY are supplied to the shift register 1302A, first, as shown by wla in FIG. 12, with respect to the first area, the writing of the SF bit Db of the subfield sf1 is started. Specifically, first, as shown in FIG. 11, the latch signals SEL1, SEL2, SEL3, . . . , and SEL8 are sequentially exclusively output from the shift register 1302A. The output circuits 1304 in which the branch numbers of the symbols are odd numbers output the pulse of the output control signal YENB1 which is supplied thereto, to the scanning lines 112 as the scanning signal in a case where the latch signals which are supplied thereto are in an H level. Accordingly, the scanning signals G1, G3, G5, G7, G9, G11, G13, and G15 are sequentially output from the output circuits 1304 in which the branch numbers of the symbols are odd numbers.

On the other hand, in the data line driving circuit 1402, first, with respect to the pixels of the first area, the SF bit Db of the subfield sf1 is latched and the latched SF bit Db is output to the data lines 114 in parallel as the data signal. Specifically, in a period in which the scanning signal G1 is output, the data signals which define the gradation of the pixels of the first row are output to the data lines 114 in parallel as the data signals d1 to d8, and the data signals d1 to d8 are stored in the write memories 110d. Further, in a period in which the scanning signal G3 is output, the data signals which define the gradation of the pixels from the third row are output to the data lines 114 in parallel as the data signals d1 to d8, and the data signals d1 to d8 are stored in the write memories 110d. If the storage of the data signals with respect to the pixels related to the first area is ended, the display control signal SET1 is kept at an H level for a predetermined time, so that the switches 110k of the pixels 110 related to the first area are closed. If the switches 110k are closed, the data signals stored in the write memories 110d are stored in the display memories 110e and the pixels 110 of the first area enter into dark states or light states depending on the data signals stored in the display memories 110e (the period of sf1 of the first area in FIG. 12).

Next, as shown by w2a in FIG. 12, with respect to the first area, the writing of the data signal of the subfield sf2 is started. Specifically, when the scanning signal G15 is output, if the start pulse DY is output and the latch signals SEL1, SEL2, SEL3, . . . , and SEL8 are sequentially exclusively output from the shift register 1302A, the scanning signals G1, G3, G5, G7, G9, G11, G13, and G15 are sequentially output again. In the data line driving circuit 1402, with respect to the pixels of the first area, the SF bit Db of the subfield sf2 is latched and the latched data signal is output to the data lines 114 in parallel. The data signals output to the data lines are stored in the write memories 110d of the pixels of the first area. Then, if the storage of the data signal with respect to the pixels of the first area is ended, the display control signal SET1 turns into an H level again, the data signal stored in the write memory 110d is stored in the display memory 110e, and the pixels 110 of the first area enter into dark states or light states depending on the data signals stored in the display memories 110e (the period of sf2 in FIG. 12).

If the writing of the SF bit Db of the subfield sf2 with respect to the first area is ended, as shown by w1b in FIG. 12, with respect to the second area, the writing of the SF bit Db of the subfield sf1 is started. Specifically, when the scanning signal G15 is output, the start pulse DY is output, the output control signal YENB1 turns into an L level, and the output control signal YENB2 is supplied to the scanning line driving circuit 130A. If the output control signal YENB2 is supplied to the output circuits 1304 in which the branch numbers of the symbols are even numbers, the scanning signals G2, G4, G6, G8, G10, G12, G14, and G16 are sequentially output from the output circuits 1304 in which the branch numbers of the symbols are even numbers.

On the other hand, in the data line driving circuit 1402, with respect to the respective pixels related to the scanning lines of the second area, the SF bit Db of the subfield sf1 is latched and the latched SF bit Db is output to the data lines 114 in parallel as the data signal. The data signals output to the data lines are stored in the write memories 110d of the pixels of the rows to which the scanning signals are output. Then, if the storage of the data signals with respect to the pixels of the second area is ended, the display control signal SET2 is kept at an H level for a predetermined time, so that the data signals stored in the write memories 110d are stored in the display memories 110e and the pixels 110 of the second area enter into dark states or light states depending on the data signals (that is, the SF bit Db of the subfield sf1) stored in the display memories 110e (the period of sf1 of the second area in FIG. 12).

Next, as shown by w2b in FIG. 12, with respect to the second area, the writing of the SF bit Db of the subfield sf2 is started. Specifically, when the scanning signal G16 is output, if the start pulse DY is output and the latch signals SEL1, SEL2, SEL3, . . . , and SEL8 are sequentially exclusively output from the shift register 1302A, the scanning signals G2, G4, G6, G8, G10, G12, G14, and G16 are sequentially output again. Here, in the data line driving circuit 1402, with respect to the pixels of the second area, the data signal representing the SF bit Db of the subfield sf2 is latched and the latched data signal is output to the data lines 114 in parallel. The data signals output to the data lines are stored in the write memories 110d of the pixels of the second area. Then, if the storage of the data signal with respect to the pixels of the second area is ended, the display control signal SET2 turns into an H level again, the data signal stored in the write memory 110d is stored in the display memory 110e, and the pixels 110 of the second area enter into dark states or light states depending on the data signals stored in the display memories 110e (the period of sf2 in FIG. 12).

Thereafter, as shown in FIG. 12, if the writing of the data signal is performed up to the subfield sf20 by alternately repeating the writing of the SF bits Db of two subfields with respect to the first area and the writing of the SF bits Db of two subfields with respect to the second area, the writing of the data signal is repeated from the subfield sf1 again.

In this embodiment as well, since the display area is divided into two equal-width areas, the write time of the data signal of one subfield in each area becomes a half compared to a case where the display area is not divided. Further, since the writing of the data signal is performed for each divided area, with respect to each area, the display period of one subfield can be shortened compared to a case where the display area is not divided. Further, in this embodiment, since the display area is divided into two toothcomb-shaped areas, the number of latch signals which are output from the shift register 1302A becomes a half of that in the first embodiment. Further, since black display that is necessarily performed at the time of the writing of a data signal is not performed, display does not become dark. Further, since the divided display areas are dispersed and disposed, a sense of discomfort at the time of moving image display can be reduced.

### Third Embodiment

Next, the third embodiment of the invention will be described. The electro-optical device 10 related to this embodiment is different in the configuration of the decoder 50, the configuration of the scanning line driving circuit 130, the configuration of the control line 115, and the supply timing of a signal in the display panel from that of the first embodiment.

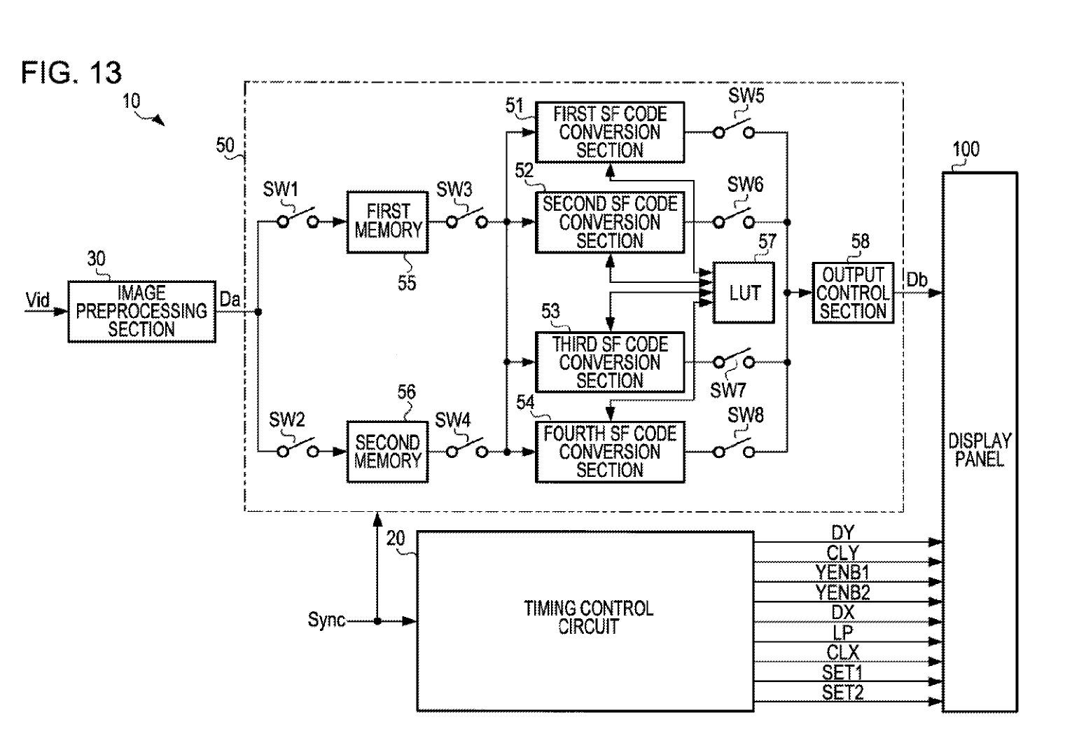

FIG. 13 is a block diagram illustrating the overall configuration of the electro-optical device 10 related to this embodiment. The decoder 50 related to this embodiment has a third SF code conversion section 53, a fourth SF code conversion section 54, a switch SW7, and a switch SW8, in addition to the configuration of the first embodiment. In the first embodiment and the second embodiment, the display area is divided into two areas. However, in this embodiment, the display area is divided into four equal-width areas arranged up and down, the first area to the fourth area. The first SF code conversion section 51 converts the video signal Da related to the pixels of the first area into the SF code with reference to the LUT 57, and the second SF code conversion section 52 converts the video signal Da related to the pixels of the second area into the SF code with reference to the LUT 57. Further, the third SF code conversion section 53 converts the video signal Da related to the pixels of the third area into the SF code with reference to the LUT 57, and the fourth SF code conversion section 54 converts the video signal Da related to the pixels of the fourth area into the SF code with reference to the LUT 57.

The switches 5 to 8 are controlled on the basis of the vertical synchronization signal and the horizontal synchronization signal that are included in the synchronization signal Sync which is supplied to the decoder 50, and when the switch SW5 is closed, the switches SW6 to SW8 are opened, and when the switch SW6 is closed, the switches SW5, SW7, and SW8 are opened. Further, when the switch SW7 is closed, the switches SW5, SW6, and SW8 are opened, and when the switch SW8 is closed, the switches SW5 to SW7 are opened.

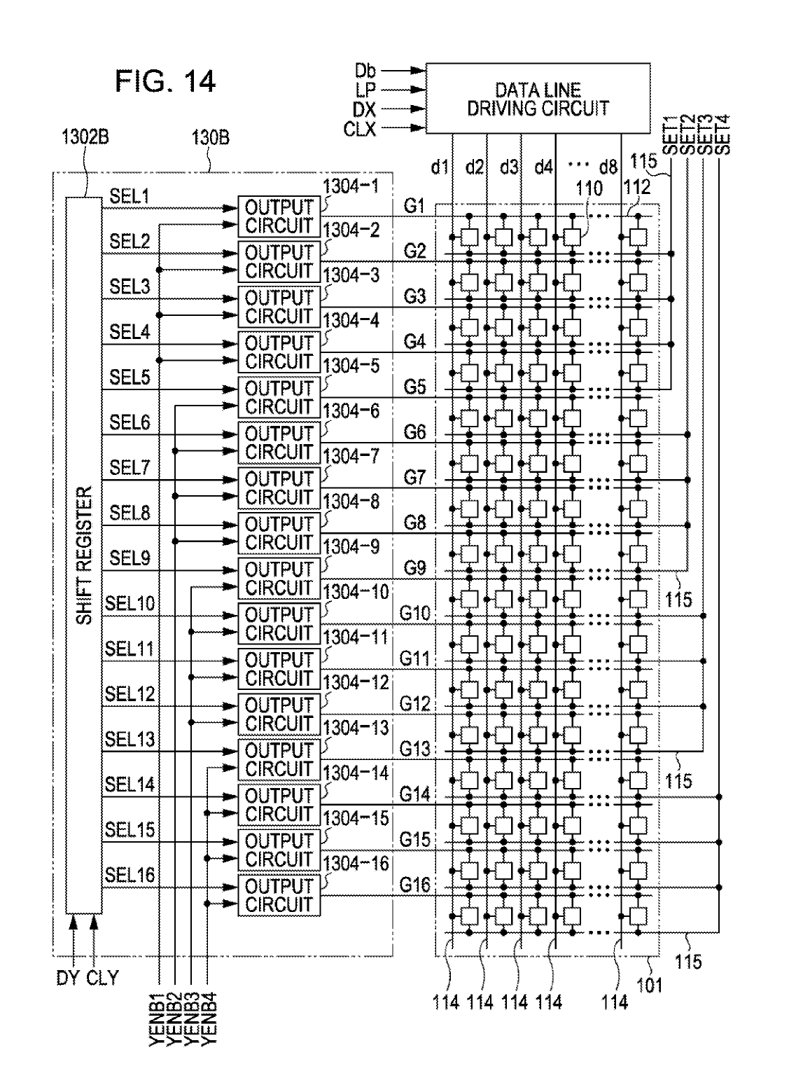

FIG. 14 is a diagram illustrating the configuration of the display panel 100 related to this embodiment. In this embodiment, the display area 101 is divided into an area (a first area) having the pixels connected to a group of the scanning lines from the first row to the fourth row, an area (a second area) having the pixels connected to a group of the scanning lines from the fifth row to the eighth row, an area (a third area) having the pixels connected to a group of the scanning lines from the ninth row to the twelfth row, and an area (a fourth area) having the pixels connected to a group of the scanning lines from the thirteenth row to the sixteenth row. That is, in the first embodiment, the scanning lines are grouped and the display area is divided into two areas arranged up and down in a strip shape. However, in this embodiment, the scanning lines are grouped into four groups and the display area is divided into four areas arranged up and down in a strip shape.

Further, in this embodiment, the control line 115 to which the display control signal SET1 that controls the switch 110k is supplied, the control line 115 to which the display control signal SET2 that controls the switch 110k is supplied, the control line 115 to which the display control signal SET3 that controls the switch 110k is supplied, and the control line 115 to which the display control signal SET4 that controls the switch 110k is supplied are present. The control line 115 to which the display control signal SET1 is supplied is connected to the pixels related to the first area, and the control line 115 to which the display control signal SET2 is supplied is connected to the pixels related to the second area. Further, the control line 115 to which the display control signal SET3 is supplied is connected to the pixels related to the third area, and the control line 115 to which the display control signal SET4 is supplied is connected to the pixels related to the fourth area.

Further, as shown in FIG. 14, in this embodiment, the display panel 100 has a scanning line driving circuit 130B. The scanning line driving circuit 130B has the shift register 1302 and the output circuits 1304-1 to 1304-16. The output control signal YENB1, the output control signal YENB2, an output control signal YENB3, and an output control signal YENB4 that are pulse signals which control the outputs of the scanning signals are supplied to the scanning line driving circuit 130B. In addition, the output control signal YENB1 is supplied to the output circuits 1304 in which the branch numbers of the symbols are 1 to 4, the output control signal YENB2 is supplied to the output circuits 1304 in which the branch numbers of the symbols are 5 to 8, the output control signal YENB3 is supplied to the output circuits 1304 in which the branch numbers of the symbols are 9 to 12, and the output control signal YENB4 is supplied to the output circuits 1304 in which the branch numbers of the symbols are 13 to 16.

The output circuits 1304 in which the branch numbers of the symbols are 1 to 4 output the pulse of the output control signal YENB1 which is supplied thereto, to the scanning lines 112 as the scanning signal in a case where the latch signals which are supplied from the shift register 1302 are in an H level. Further, the output circuits 1304 having the branch numbers of 5 to 8 output the pulse of the output control signal YENB2 which is supplied thereto, to the scanning lines 112 as the scanning signal in a case where the latch signals which are supplied from the shift register 1302 are in an H level. Further, the output circuits 1304 having the branch numbers of 9 to 12 output the pulse of the output control signal YENB3 which is supplied thereto, to the scanning lines 112 as the scanning signal in a case where the latch signals which are supplied from the shift register 1302 are in an H level. Further, the output circuits 1304 having the branch numbers of 13 to 16 output the pulse of the output control signal YENB4 which is supplied thereto, to the scanning lines 112 as the scanning signal in a case where the latch signals which are supplied from the shift register 1302 are in an H level.

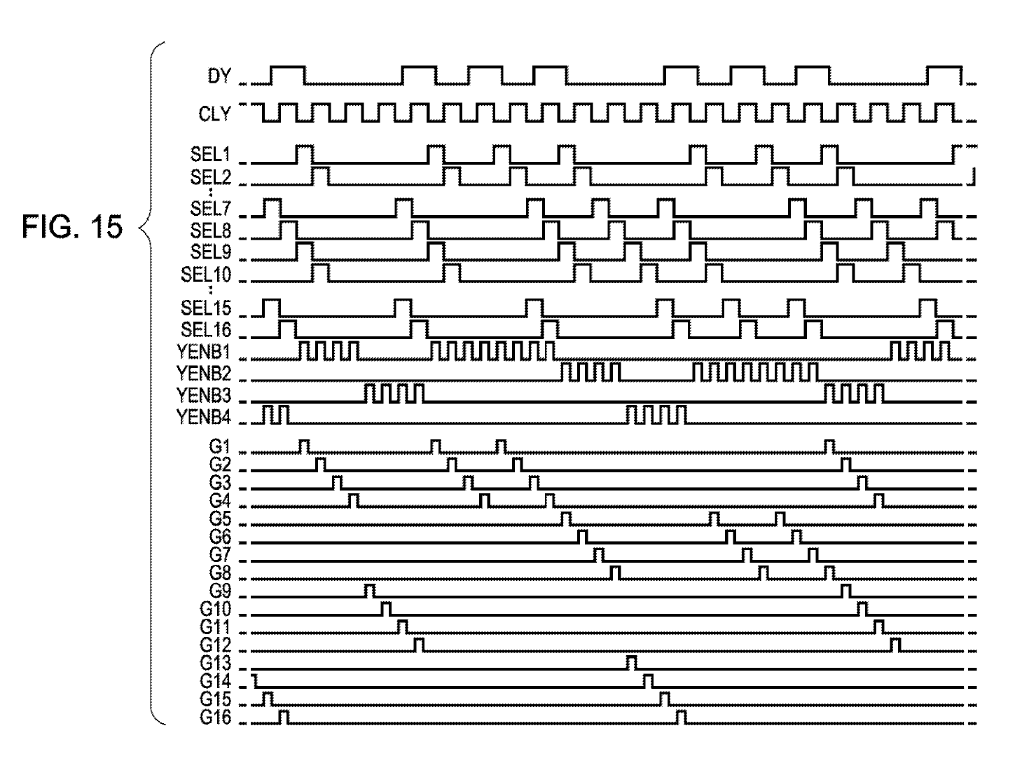

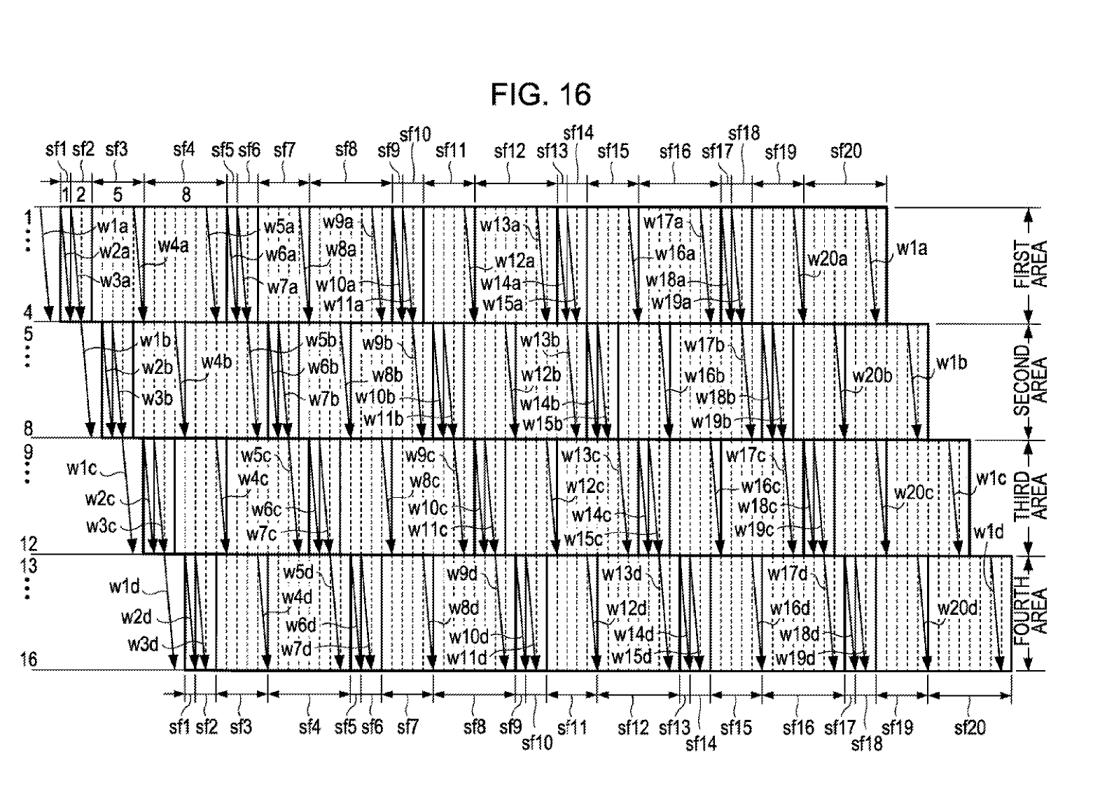

Next, an operation in this embodiment will be described. FIG. 15 is a timing chart for describing an operation of the display panel related to this embodiment. Further, FIG. 16 is a diagram illustrating the progress of the writing of data to the pixels in each display area.

First, a write operation of the data signal to the first area will be described. If the start pulse DY and the clock signal CLY are supplied to the shift register 1302, as shown by wla in FIG. 16, with respect to the first area, the writing of the SF bit Db of the subfield sf1 is started. Specifically, as shown in FIG. 15, the latch signals SEL1, SEL2, SEL3, . . . , and SEL16 are sequentially exclusively output from the shift register 1302. The output circuits 1304-1 to 1304-4 output the pulse of the output control signal YENB1 which is supplied thereto, to the scanning lines 112 as the scanning signal in a case where the latch signals which are supplied thereto are in an H level. Accordingly, the scanning signals G1 to G4 are sequentially output from the output circuits 1304-1 to 1304-4.

On the other hand, in the data line driving circuit 1402, first, with respect to the pixels of the first area, the SF bit Db of the subfield sf1 is latched and the latched SF bit Db is output to the data lines 114 in parallel as the data signal. The data signals output to the data lines 114 are stored in the write memories 110d of the pixels in which the scanning signal is in an H level.

After the writing of the SF bit Db of the subfield sf1 with respect to the first area is ended, if a time (hereinafter referred to as a time t1) required for writing data for one subfield with respect to one area elapses, as shown by w2a in FIG. 16, with respect to the first area, the writing of the SF bit Db of the subfield sf2 is started. In addition, at the point of time when this writing is started, the display control signal SET1 is kept at an H level for a predetermined time, so that the data signals stored in the write memories 110d are stored in the display memories 110e and the pixels 110 of the first area enter into dark states or light states depending on the data signals stored in the display memories 110e (the period of sf1 of the first area in FIG. 16). Then, if the writing of the SF bit Db of the subfield sf2 with respect to the first area is ended, the display control signal SET1 turns into an H level again and the pixels 110 of the first area enter into dark states or light states depending on the data signals (that is, the SF bit Db of the subfield sf2) stored in the display memories 110e (the period of sf2 of the first area in FIG. 16).

If the writing of the SF bit Db of the subfield sf2 with respect to the first area is ended, as shown by w3a in FIG. 16, with respect to the first area, the writing of the SF bit Db of the subfield sf3 is started. Then, if the writing of the SF bit Db of the subfield sf3 with respect to the pixels of the first area is ended, after the time t1 elapses, the display control signal SET1 turns into an H level, so that the pixels 110 of the first area enter into dark states or light states depending on the data signals (that is, the SF bit Db of the subfield sf3) stored in the display memories 110e (the period of sf3 in FIG. 16).

If the writing of the SF bit Db of the subfield sf3 with respect to the first area is ended, after the time of time t1×5 elapses, as shown by w4a in FIG. 16, with respect to the first area, the writing of the SF bit Db of the subfield sf4 is started. Then, if the writing of the SF bit Db of the subfield sf4 with respect to the pixels of the first area is ended, after the time t1 elapses, the display control signal SET1 turns into an H level, so that the pixels 110 of the first area enter into dark states or light states depending on the data signals stored in the display memories 110e (the period of sf4 in FIG. 16).

Hereafter, with respect to the first area, as shown in FIG. 16, with respect to the subfields sf5 to sf8, the SF bits Db are written in the same order as that of the writing of the SF bits Db of the subfields sf1 to sf4. Further, also with respect to the subfields sf9 to sf12 and the subfields sf13 to sf16, the SF bits Db are written in the same order as that of the writing of the SF bits Db of the subfields sf1 to sf4.

Next, a write operation of the data signal to the second area will be described. The writing of the SF bit Db to the second area is started from the point of time when the writing of the SF bit Db of the subfield sf3 of the first area is ended. First, as shown by w1b in FIG. 16, if the writing of the SF bit Db of the subfield sf3 of the first area is ended, the writing of the SF bit Db of the subfield sf1 of the second area is started. If this writing is ended, after the time t1 elapses, the display control signal SET2 is kept at an H level for a predetermined time, so that the pixels 110 of the second area enter into dark states or light states depending on the data signals (the SF bit Db of the subfield sf1) stored in the display memories 110e.

If the writing of the SF bit Db of the subfield sf1 is ended, as shown by w2b in FIG. 16, the writing of the SF bit Db of the subfield sf2 of the second area is started. If the writing of the SF bit Db of the subfield sf2 is ended, the display control signal SET2 turns into an H level, so that the pixels 110 of the second area enter into dark states or light states depending on the data signals (the SF bit Db of the subfield sf2) stored in the display memories.

Further, if the writing of the SF bit Db of the subfield sf2 is ended, as shown by w3b in FIG. 16, the writing of the SF bit Db of the subfield sf3 of the second area is started. If the writing of the SF bit Db of the subfield sf3 is ended, after the time t1 elapses, the display control signal SET2 turns into an H level, so that the pixels 110 of the second area enter into dark states or light states depending on the data signals (the SF bit Db of the subfield sf3) stored in the display memories 110e.

If the writing of the SF bit Db of the subfield sf3 with respect to the second area is ended, after the time of time t1×5 elapses, the writing of the SF bit Db of the subfield sf4 with respect to the second area is started. Then, if the writing of the SF bit Db of the subfield sf4 is ended, after the time t1 elapses, the display control signal SET2 turns into an H level, so that the pixels 110 of the second area enter into dark states or light states depending on the data signals (the SF bit Db of the subfield sf4) stored in the display memories 110e.

Hereafter, with respect to the second area, as shown in FIG. 16, with respect to the subfields sf5 to sf8, the SF bits Db are written in the same order as that of the writing of the SF bits Db of the subfields sf1 to sf4. Further, also with respect to the subfields sf9 to sf12 and the subfields sf13 to sf16, the SF bits Db are written in the same order as that of the writing of the SF bits Db of the subfields sf1 to sf4.

Next, a write operation of the data signal to the third area will be described. The writing of the SF bit Db to the third area is started from the point of time when the writing of the SF bit Db of the subfield sf3 of the second area is ended. First, as shown by wlc in FIG. 16, if the writing of the SF bit Db of the subfield sf3 of the second area is ended, the writing of the SF bit Db of the subfield sf1 of the third area is started. If this writing is ended, after the time t1 elapses, the display control signal SET3 is kept at an H level for a predetermined time, so that the pixels 110 of the third area enter into dark states or light states depending on the data signals stored in the display memories 110e.

If the writing of the SF bit Db of the subfield sf1 is ended, as shown by w2c in FIG. 16, the writing of the SF bit Db of the subfield sf2 of the third area is started. If the writing of the SF bit Db of the subfield sf2 is ended, the display control signal SET3 turns into an H level, so that the pixels 110 of the third area enter into dark states or light states depending on the data signals (the SF bit Db of the subfield sf2) stored in the display memories.

Further, if the writing of the SF bit Db of the subfield sf2 is ended, as shown by w3c in FIG. 16, the writing of the SF bit Db of the subfield sf3 of the third area is started. If the writing of the SF bit Db of the subfield sf3 is ended, after the time t1 elapses, the display control signal SET3 turns into an H level, so that the pixels 110 of the third area enter into dark states or light states depending on the data signals (the SF bit Db of the subfield sf3) stored in the display memories 110e.

If the writing of the SF bit Db of the subfield sf3 with respect to the third area is ended, after the time of time t1×5 elapses, the writing of the SF bit Db of the subfield sf4 with respect to the third area is started. Then, if the writing of the SF bit Db of the subfield sf4 is ended, after the time t1 elapses, the display control signal SET3 turns into an H level, so that the pixels 110 of the third area enter into dark states or light states depending on the data signals (the SF bit Db of the subfield sf4) stored in the display memories 110e.

Hereafter, with respect to the third area, as shown in FIG. 16, with respect to the subfields sf5 to sf8, the SF bits Db are written in the same order as that of the writing of the SF bits Db of the subfields sf1 to sf4. Further, also with respect to the subfields sf9 to sf12 and the subfields sf13 to sf16, the SF bits Db are written in the same order as that of the writing of the SF bits Db of the subfields sf1 to sf4.

Next, a write operation of the data signal to the fourth area will be described. The writing of the SF bit Db to the fourth area is started from the point of time when the writing of the SF bit Db of the subfield sf3 of the third area is ended. First, as shown by w1d in FIG. 16, if the writing of the SF bit Db of the subfield sf3 of the third area is ended, the writing of the SF bit Db of the subfield sf1 of the fourth area is started. If this writing is ended, after the time t1 elapses, the display control signal SET4 is kept at an H level for a predetermined time, so that the pixels 110 of the fourth area enter into dark states or light states depending on the data signals stored in the display memories 110e (the period of sf1 of the fourth area in FIG. 16).

If the writing of the SF bit Db of the subfield sf1 is ended, as shown by w2d in FIG. 16, the writing of the SF bit Db of the subfield sf2 of the fourth area is started. If the writing of the SF bit Db of the subfield sf2 is ended, the display control signal SET4 turns into an H level, so that the pixels 110 of the fourth area enter into dark states or light states depending on the data signals (the SF bit Db of the subfield sf2) stored in the display memories (the period of sf2 of the fourth area in FIG. 16).

Further, if the writing of the SF bit Db of the subfield sf2 is ended, as shown by wad in FIG. 16, the writing of the SF bit Db of the subfield sf3 of the fourth area is started. If the writing of the SF bit Db of the subfield sf3 is ended, after the time t1 elapses, the display control signal SET4 turns into an H level, so that the pixels 110 of the fourth area enter into dark states or light states depending on the data signals (the SF bit Db of the subfield sf3) stored in the display memories 110e (the period of sf3 of the fourth area in FIG. 16).

If the writing of the SF bit Db of the subfield sf3 with respect to the fourth area is ended, after the time of time t1×5 elapses, the writing of the SF bit Db of the subfield sf4 with respect to the fourth area is started. Then, if the writing of the SF bit Db of the subfield sf4 is ended, after the time t1 elapses, the display control signal SET4 turns into an H level, so that the pixels 110 of the fourth area enter into dark states or light states depending on the data signals (the SF bit Db of the subfield sf4) stored in the display memories 110e (the period of sf4 of the fourth area in FIG. 16).

Hereafter, with respect to the fourth area, as shown in FIG. 16, with respect to the subfields sf5 to sf8, the SF bits Db are written in the same order as that of the writing of the SF bits Db of the subfields sf1 to sf4. Further, also with respect to the subfields sf9 to sf12 and the subfields sf13 to sf16, the SF bits Db are written in the same order as that of the writing of the SF bits Db of the subfields sf1 to sf4.

According this embodiment, since the display area is divided into four equal-width areas, the write time of the data signal of one subfield in each area becomes ¼ compared to a case where the display area is not divided. Further, since the writing of the data signal is performed for each divided area, with respect to each area, the display period of one subfield can be shortened compared to a case where the display area is not divided. In order to obtain low gradation in the subfield driving, a short subfield period is required. However, in this embodiment, since a short subfield period can be realized, it becomes possible to display low gradation. Further, in this embodiment, as shown in FIG. 16, weighting can be set to be 1:2:5:8 in four consecutive subfields, so that it is possible to display various gradations. Further, since black display that is necessarily performed at the time of the writing of a data signal is not performed, display does not become dark.

### Fourth Embodiment

Next, the fourth embodiment of the invention will be described. This embodiment is different in the configuration of the scanning line driving circuit 130, the configuration of the control line 115, and the supply timing of a signal in the display panel from that of the third embodiment.

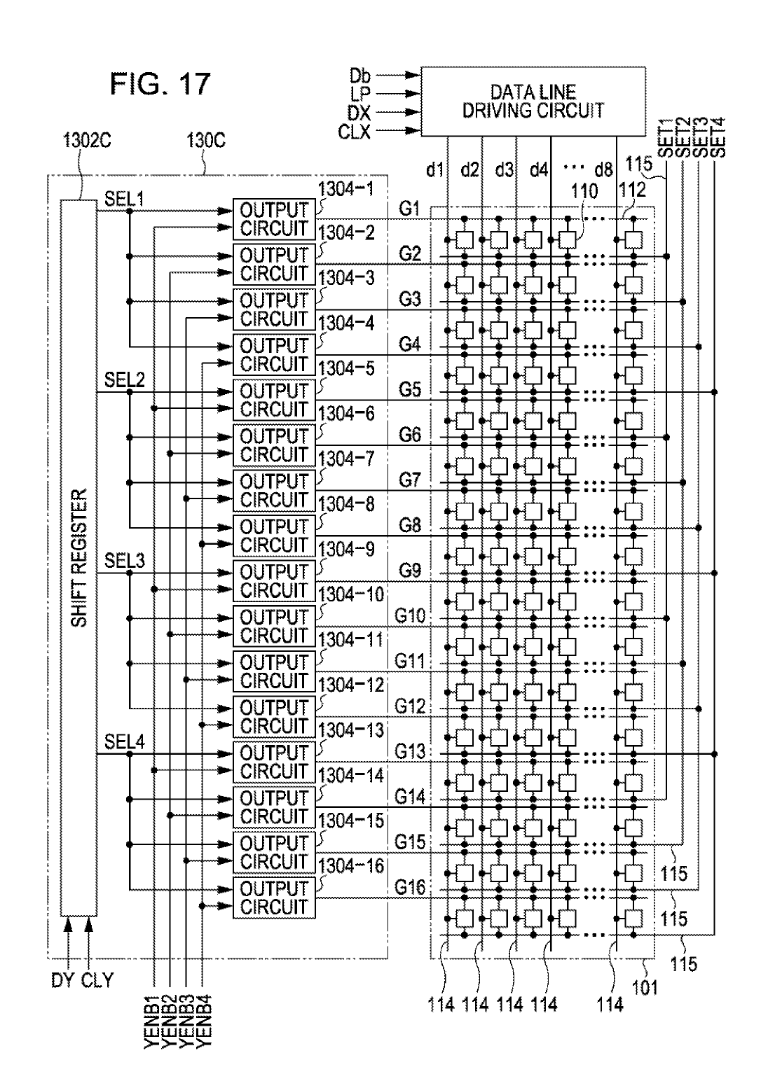

FIG. 17 is a diagram illustrating the configuration of the display panel 100 related to this embodiment. In this embodiment, the display area 101 is divided into an area (a first area) having the pixels connected to a group of the scanning lines of the first row, the fifth row, the ninth row, and the thirteenth row, an area (a second area) having the pixels connected to a group of the scanning lines of the second row, the sixth row, the tenth row, and fourteenth row, an area (a third area) having the pixels connected to a group of the scanning lines of the third row, the seventh row, the eleventh row, and the fifteenth row, and an area (a fourth area) having the pixels connected to a group of the scanning lines of the fourth row, the eighth row, the twelfth row, and the sixteenth row. That is, in the third embodiment, the scanning lines are grouped into four groups by the successive scanning lines and the display area is divided into four areas arranged up and down in a strip shape. However, in this embodiment, the scanning lines are grouped in a toothcomb shape and the first to fourth areas are made in a toothcomb shape.

Further, in this embodiment, the control line 115 to which the display control signal SET1 is supplied is connected to the pixels connected to the scanning lines of the first row, the fifth row, the ninth row, and the thirteenth row, and the control line 115 to which the display control signal SET2 is supplied is connected to the pixels connected to the scanning lines of the second row, the sixth row, the tenth row, and fourteenth row. Further, the control line 115 to which the display control signal SET3 is supplied is connected to the pixels connected to the scanning lines of the third row, the seventh row, the eleventh row, and the fifteenth row, and the control line 115 to which the display control signal SET4 is supplied is connected to the pixels connected to the scanning lines of the fourth row, the eighth row, the twelfth row, and the sixteenth row.

Further, as shown in FIG. 17, in this embodiment, the display panel 100 has a scanning line driving circuit 130C. The scanning line driving circuit 130C has a shift register 1302C and the output circuits 1304-1 to 1304-16. The output control signal YENB1, the output control signal YENB2, the output control signal YENB3, and the output control signal YENB4 that control the outputs of the scanning signals are supplied to the scanning line driving circuit 130C. When the start pulse DY that is supplied at the timing of the write start of data of the subfield is in an H level, if the clock signal CLY falls, the shift register 1302C sequentially exclusively outputs the latch signals SEL1, SEL2, SEL3, and SEL4 that are pulse signals, in accordance with the clock signal CLY.

The output circuits 1304 in which the branch numbers of the symbols are 1, 5, 9, and 13 output the pulse of the output control signal YENB1 which is supplied thereto, to the scanning lines 112 as the scanning signal in a case where the latch signals which are supplied from the shift register 1302C are in an H level. Further, the output circuits 1304 in which the branch numbers of the symbols are 2, 6, 10, and 14 output the pulse of the output control signal YENB2 which is supplied thereto, to the scanning lines 112 as the scanning signal in a case where the latch signals which are supplied from the shift register 1302C are in an H level. Further, the output circuits 1304 in which the branch numbers of the symbols are 3, 7, 11, and 15 output the pulse of the output control signal YENB3 which is supplied thereto, to the scanning lines 112 as the scanning signal in a case where the latch signals which are supplied from the shift register 1302C are in an H level. Further, the output circuits 1304 in which the branch numbers of the symbols are 4, 8, 12, and 16 output the pulse of the output control signal YENB4 which is supplied thereto, to the scanning lines 112 as the scanning signal in a case where the latch signals which are supplied from the shift register 1302C are in an H level.

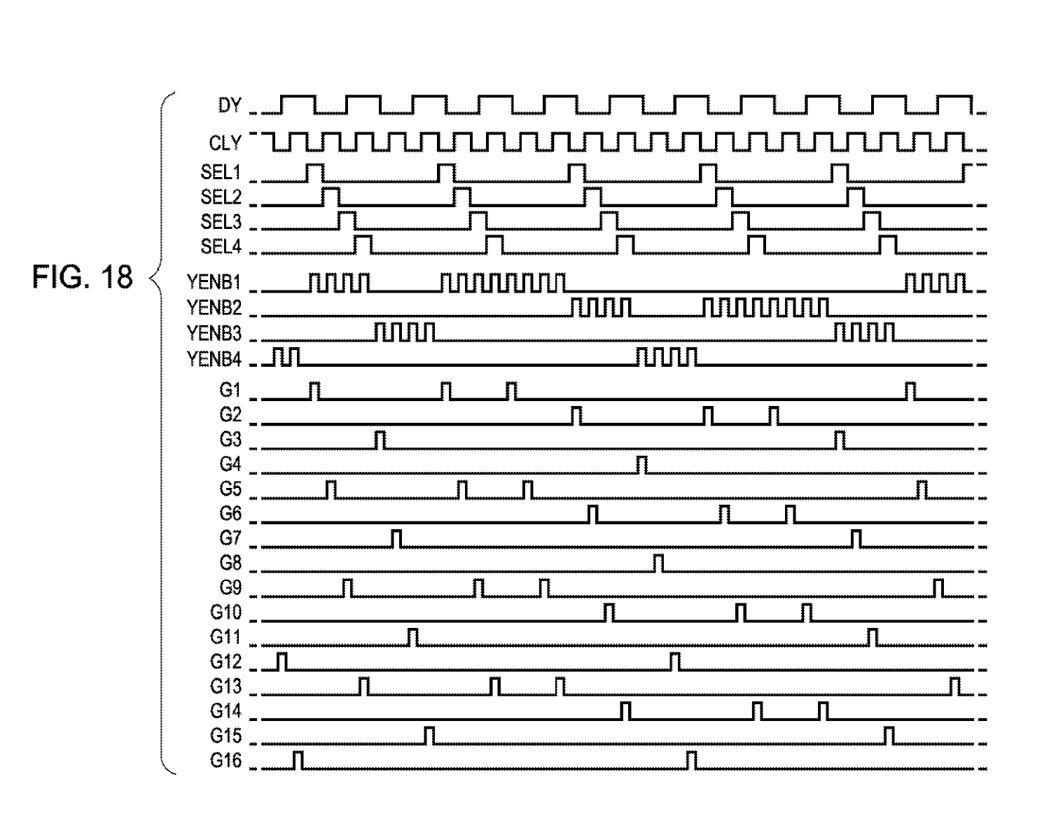

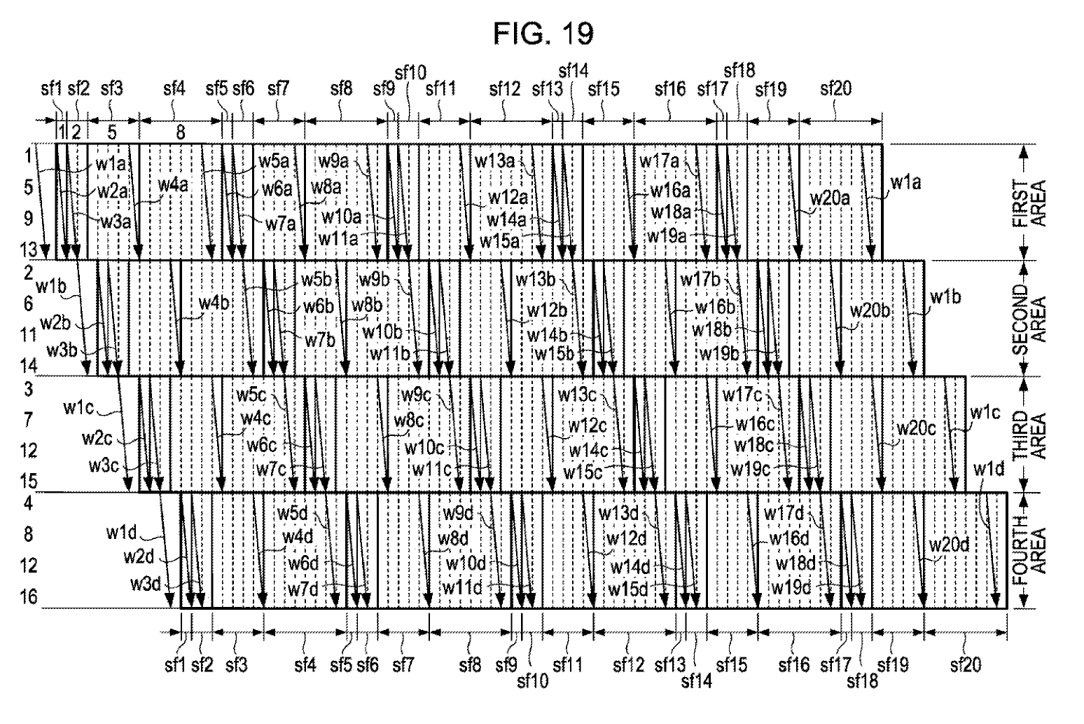

FIG. 18 is a timing chart for describing an operation of the display panel related to this embodiment. Further, FIG. 19 is a diagram illustrating the progress of the writing of data to the pixels in each display area. As shown in FIGS. 18 and 19, in this embodiment, the scanning lines related to each area are different from those in the third embodiment. However, in each area, the timing of the writing of the SF bit Db and the display period of each subfield are the same as those in the third embodiment.

According to this embodiment, since the display area is divided into four areas, the write time of the data signal of one subfield in each area becomes ¼ compared to a case where the display area is not divided. Further, since the writing of the data signal is performed for each divided area, with respect to each area, the display period of one subfield can be shortened compared to a case where the display area is not divided. Further, in this embodiment, since the display area is divided into four areas in a toothcomb shape, the number of latch signals which are output from the shift register 1302C becomes ¼ of that in the first embodiment. Further, in this embodiment as well, as shown in FIG. 19, weighting can be set to be 1:2:5:8 in four consecutive subfields, so that it is possible to display various gradations. Further, since black display that is necessarily performed at the time of the writing of a data signal is not performed, display does not become dark. Further, since the divided display areas are dispersed and disposed, a sense of discomfort at the time of moving image display can be reduced.

### Electronic Equipment

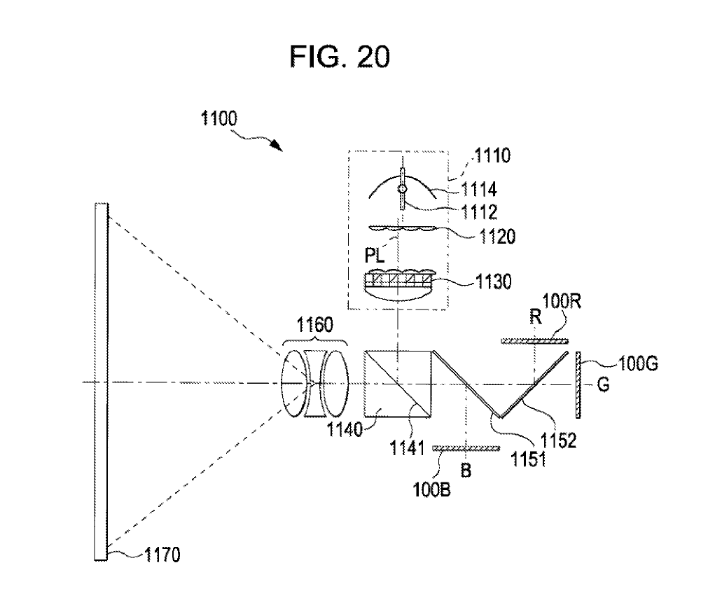

Next, electronic equipment to which the reflection type liquid crystal panel 100 related to the above-described embodiments is applied will be described. FIG. 20 is a plan view showing the configuration of a projector 1100 using the liquid crystal panel 100 as a light valve. As shown in this drawing, the projector 1100 is a three-plate type in which the reflection type liquid crystal panels 100 related to the embodiments are provided corresponding to the respective colors of R (red), G (green), and B (blue). In the inside of the projector 1100, a polarization illuminating device 1110 is disposed along a system optical axis PL. In the polarization illuminating device 1110, emitted light from a lamp 1112 turns into a parallel light flux by reflection by a reflector 1114 and is then incident on a first integrator lens 1120. The emitted light from the lamp 1112 is divided into a plurality of intermediate light fluxes by the first integrator lens 1120. The divided intermediate light fluxes are converted into one type of polarized light fluxes (s-polarized light fluxes) in which polarization directions are approximately aligned, by a polarization conversion element 1130 having a second integrator lens on the light incidence side, and then emitted from the polarization illuminating device 1110.

The s-polarized light fluxes emitted from the polarization illuminating device 1110 are reflected by an s-polarized light flux reflecting plane 1141 of a polarization beam splitter 1140. Among the reflected light fluxes, a light flux of blue light (B) is reflected on a blue light reflection layer of a dichroic mirror 1151 and then modulated by a liquid crystal panel 100B. Further, among the light fluxes which have penetrated the blue light reflection layer of the dichroic mirror 1151, a light flux of red light (R) is reflected on a red light reflection layer of a dichroic mirror 1152 and then modulated by a liquid crystal panel 100R. On the other hand, among the light fluxes which have penetrated the blue light reflection layer of the dichroic mirror 1151, a light flux of green light (G) penetrates the red light reflection layer of the dichroic mirror 1152 and is then modulated by a liquid crystal panel 100G.

Here, each of the liquid crystal panels 100R, 100G, and 100B is the same as the liquid crystal panel 100 in the above-described embodiments and is driven by a video signal corresponding to each color of R, G, and B which is supplied. That is, in the projector 1100, three sets of liquid crystal panels 100 are provided to correspond to the respective colors of R, G, and B and configured to be respectively driven by video signals corresponding to the respective colors of R, G, and B.

The red light, the green light, and the blue light respectively modulated by the liquid crystal panels 100R, 100G, and 100B are sequentially combined by the dichroic mirrors 1152 and 1151 and the polarization beam splitter 1140 and then projected onto a screen 1170 by a projection optical system 1160. Since the light fluxes corresponding to the respective primary colors of R, G, and B are incident on the liquid crystal panels 100R, 100B, and 100G by the dichroic mirrors 1151 and 1152, color filters are not required. In addition, as the electronic equipment, in addition to the projector described with reference to FIG. 20, a rear projection type television, a head-mounted display, and the like can be given.

### MODIFIED EXAMPLES

The embodiments of the invention have been described above. However, the invention is not limited to the above-described embodiments and can be implemented in various other forms. For example, the invention may also be implemented by modifying the above-described embodiments as follows and may also be implemented by combining the respective modified examples.

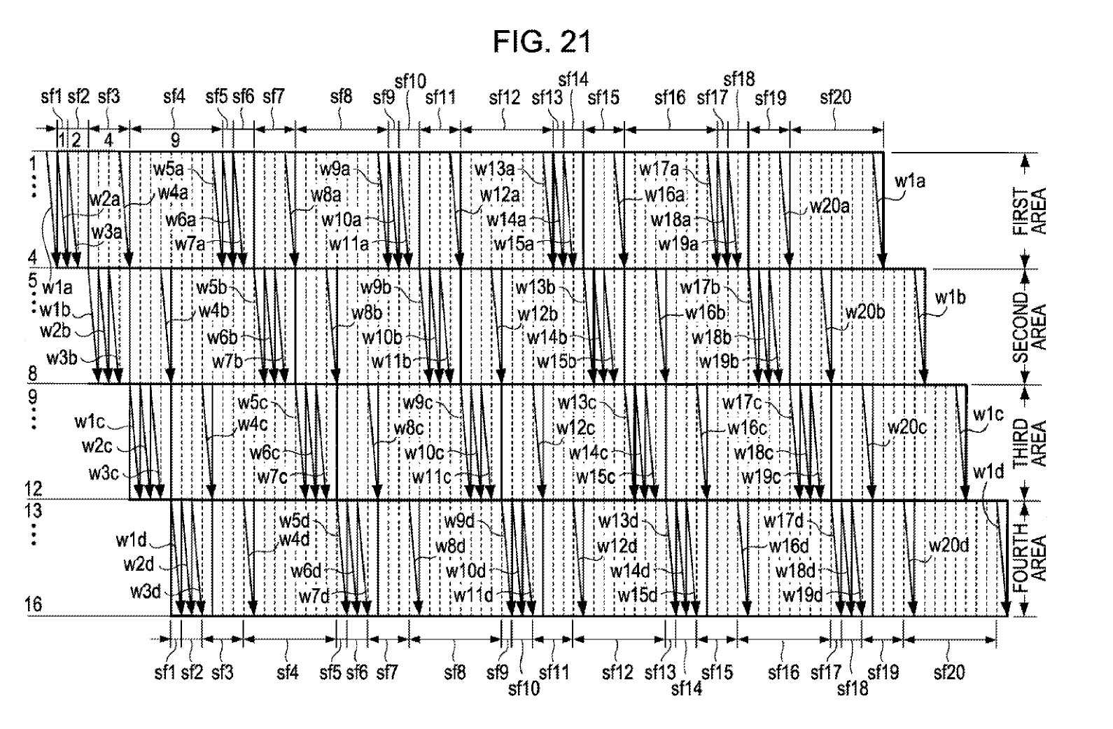

In the third embodiment and the fourth embodiment described above, weighting is set to be 1:2:5:8 in four consecutive subfields. However, the weighting is not limited to this ratio. For example, in the third embodiment or the fourth embodiment, it is also acceptable that the writing timing of the SF bit Db of each subfield is set to be the timing shown in FIG. 21 and the weighting of four consecutive subfields is set to be 1:2:4:9.

In the embodiments described above, the liquid crystal 110j is set to be a normally black mode. However, the liquid crystal 110j may also be set to be a normally white mode in which the liquid crystal element 110g enters into a white state at the time of non-application of voltage, as a TN system, for example. Further, in the embodiments described above, the liquid crystal panel 100 is made to be a reflection type. However, the liquid crystal panel 100 may also be a transmission type.

Further, in the embodiments described above, the electro-optical material is liquid crystal. However, the electro-optical material is not limited to the liquid crystal and may also be, for example, an electroluminescent material.

In the embodiments described above, the value of the SF bit c20 may also be set to be 0, that is, OFF driving, even in any gradation of gradations from 0 to 255. According to this configuration, in a case where the liquid crystal element 110g performs alternating-current driving by changing voltage that is applied to the opposite electrode 110i, before the applied voltage is changed, voltage that is applied to the liquid crystal element 110g turns into 0 V (or around 0 V), so that it is possible to reduce a difference in potential between adjacent pixels when inverting the polarity of the applied voltage.

This application claims priority to Japan Patent Application No. 2011-004278 filed Jan. 12, 2011, the entire disclosures of which are hereby incorporated by reference in their entireties.

What is claimed is:

1. An electro-optical device comprising:
a pixel provided corresponding to a intersection of a scanning line with a data line; and
a driving circuit that supplies a subfield data, to the data line in a subfield, that constituted by a bit array according to a gradation level, the subfield is obtained by dividing one frame into a plurality of subfields,
wherein the pixel includes:
a first memory which is connected to the scanning line and the data line and stores the subfield data supplied to the data line when the scanning line has been selected;
a second memory which stores the subfield data stored in the first memory; and
a pixel driving circuit which on-drives or off-drives the pixel depending on the subfield data stored in the second memory, and
wherein the electro-optical device includes a plurality of scanning lines that are grouped into a plurality of groups, the driving circuit that selects each of the plurality of groups in a predetermined order, and supplies the subfield data to the data line and writes the subfield data to the first memory and then writes the subfield data stored in the first memory to the second memory, the plurality of subfields have at least two different weightings, and the plurality of groups each includes the subfield that be provide with a different timings.

2. The electro-optical device according to claim 1, wherein in the plurality of groups, the scanning line that belong to another group are located between the plurality of scanning lines that belong to one group.

3. The electro-optical device according to claim 1, wherein the pixel is alternating-current driven, and a bit corresponding to the last sub-frame in one frame in the subfield data is a bit that off-drives the pixel.

4. A method of driving an electro-optical device that includes a plurality of pixels which is provided corresponding to the respective intersections of a plurality of scanning lines with a plurality of data lines and includes a first memory and a second memory, and the plurality of scanning lines are grouped into a plurality of groups; the method comprising:
selecting the plurality of groups in a predetermined order, writing a bit based on a subfield data to the first memory of a selected pixel among the plurality of pixels, and storing the content of the first memory in the second memory of the selected pixel after the writing is ended,
wherein at least two different weightings are given to a plurality of subfields and the plurality of subfields are assigned at different timings with respect to each of the plurality of groups.

5. Electronic equipment comprising the electro-optical device according to claim 1.

6. Electronic equipment comprising the electro-optical device according to claim 2.

7. Electronic equipment comprising the electro-optical device according to claim 3.
